(19) United States
(12) Patent Application Publication
(10) Pub. No.: US 2016/0318776 A1
(43) Pub. Date: Nov. 3, 2016

(54) APPARATUS FOR SEPARATING AND COLLECTING OIL SPILLED IN OCEAN

(71) Applicant: GAUDO CO., LTD., Buk-gu Gwangju (KR)

(72) Inventor: Jong In KIM, Gwangju (KR)

(21) Appl. No.: 14/398,775

(22) PCT Filed: Mar. 19, 2014
(86) PCT No.: PCT/KR2014/002319

§ 371 Date: Nov. 4, 2014

(30) Foreign Application Priority Data
Jan. 20, 2014 (KR) 10-2014-0006927

(51) Int. Cl. C02F 1/40; E02B 15/04; B63B 35/32; B01D 17/02

(52) U.S. Cl. CPC C02F 1/40; B01D 17/0214; B01D 17/0217; E02B 15/045; B63B 35/32; C02F 2101/32

(57) ABSTRACT

Provided is an apparatus for separating and collecting oil spilled in an ocean, which is capable of easily removing the oil spilled in rivers, reservoirs, or oceans using a density difference between water and oil. The apparatus for separating and collecting oil spilled in the ocean according to the present invention includes a separator body having a separation space therein formed to receive mixed water in which water and oil are mixed, and a mixed water introducing part formed at one side thereof to introduce the mixed water, a drainage member which is installed in the separation space, and in which an end thereof is connected and in communication with the separator body to be located lower than a level of the water, such that the water separated from the oil due to a density difference is discharged to an outer side of the separator body, and a length adjusting part configured to move a height of an upper end of the drainage member exposed to the outer side of the separator body vertically to control the level of the water in the separator body.

### TECHNICAL FIELD

The present invention relates to an apparatus for separating and collecting oil spilled in an ocean, and more particularly, to an apparatus for separating and collecting oil spilled in an ocean, which is capable of easily removing the oil spilled in a river, reservoir, or ocean using a density difference between water and oil.

### BACKGROUND ART

It is a very big problem that threatens the health of the river or reservoir citrus. Recently, oil spill accidents have occurred due to various causes such as oil spills at industrial sites, accidents of tank trucks or oil tankers, and ship grounding. To remove the spilled oil, various methods such as a chemical treatment method, a method using an oil-absorbing fabric, and a manual oil removing method are used.

In addition to, a weir type oil skimmer having an excellent oil collecting effect has recently been used more than the above methods. The weir type oil skimmer such as an oil-water separator described in Korean Patent No. 10-1139933 includes a housing which is supported by a buoyant body to be located just below a surface of water, an oil-water separator, and a pump which transports water (containing oil) introduced into the housing to the oil-water separator. In such an oil separating device, when the water (hereinafter called “contaminated water” for the sake of convenience) mixed with oil is introduced into the housing, the contaminated water is forcibly transported to the oil-water separator by an operation of the pump. After a process of separating oil from water is carried out in the oil-water separator, the water is discharged to an outer side, and the oil separated from the water is introduced into a storage tank.

The weir type oil skimmer has more excellent oil separating performance than the above-mentioned general methods. However, since oil is characterized by being thinly spread on a surface of water when it comes in contact with the water, an excessive amount of the water (corresponding to about 70 to 90% of the total contaminated water) is introduced into the housing, compared with an amount of the oil. Further, while the contaminated water is transported to the oil-water separator using the pump, oil drops are mixed with the water by rotation of an impeller in the pump, and thus it becomes harder to separate the oil from the water.

In addition, various types of oil-water separators have been developed, but the oil-water separation effect thereof is inadequate. In the case of the ocean, when a large amount of oil is spilled in the ocean due to an accident of an oil tanker or a ship, an oil block fence is still installed, and then the oil on the surface of the water is absorbed and removed by an oil absorbing fabric, or an expensive apparatus such as a trawl is mainly used.

### DISCLOSURE

### Technical Problem

The present invention is directed to providing an apparatus for separating and collecting oil spilled in an ocean, which can effectively separate oil and water from contaminated water due to an oil spill using a difference of specific gravity between the oil and the water.

### Technical Solution

One aspect of the present invention provides an apparatus for separating and collecting oil spilled in an ocean, including a separator body having a separation space therein formed to receive mixed water in which water and oil are mixed, and a mixed water introducing part formed at one side thereof to introduce the mixed water, and a drainage unit which is installed in the separation space, and in which an end thereof is connected and in communication with the separator body to be located lower than a level of the water, such that the water separated from the oil due to a density difference is discharged to an outer side of the separator body.

The drainage unit may include a drainage member which is installed in the separation space, and in which an end thereof is connected and in communication with the separator body to be located lower side the level of the water, such that the water separated from the oil due to the density difference is discharged to the outer side of the separator body, and a length adjusting part configured to move a height of an upper end of the drainage member exposed to the outer side of the separator body vertically to control the level of the water in the separator body.

The separator body may have the mixed water introducing part formed at one side thereof, and an oil discharging part formed at an upper portion thereof so that the oil is discharged therethrough, and the drainage member may have a first drainage pipe installed in the separator body to extend vertically and having an inlet port to allow the water, from which the oil is separated, to be introduced therethrough, a second drainage pipe configured to extend from a lower end of the first drainage pipe to an outer side of the separator body, a third drainage pipe configured to extend upward from an end of the second drainage pipe, and a fourth drainage pipe configured to extend from an upper end of the third drainage pipe to be horizontally or downward inclined, and the length adjusting part may be installed at the third drainage pipe to move a height of an upper end of the third drainage pipe vertically.

The length adjusting part may be formed at one side of the third drainage pipe, and configured with a bellows tube which is contractible and expandable.

The length adjusting part may include an internal pipe formed at the upper end of the third drainage pipe to extend upward, an external pipe formed to surround an outer circumferential surface of the internal pipe and to be moved vertically, and a sealing member installed at the internal pipe or the external pipe to prevent the water from leaking through a gap between the internal pipe and the external pipe.

The length adjusting part may include a bellows tube formed at one side of the third drainage pipe to be expandable or contractible, an upper panel installed at an upper end of the bellows tube, a lower panel installed at a lower end of the bellows tube, a screw member configured to extend downward from the upper panel so as to pass through the lower panel and having a screw thread formed on an outer circumferential surface thereof, a worm wheel member rotatably installed at the lower panel and having a hollow through which the screw member passes and a screw thread formed on an inner circumferential surface of the hollow to be screwed with the screw member, a worm engaged with an outer circumferential surface of the worm wheel member, and a driving motor connected with the worm to rotate the worm.

The length adjusting part may include a flexible tube provided between the second drainage pipe and the third drainage pipe, and an actuator configured to pivot the third drainage pipe vertically about the flexible tube.

The length adjusting part may include a bellows tube formed at one side of the third drainage pipe to be expandable or contractible, a connection part installed at an upper portion of the bellows tube to be connected with the third drainage pipe, a connection rod configured to extend from the connection part toward the separator body, a first moving member connected with the connection rod to be moved vertically along the separator body, a second moving member formed in the separator body to be moved vertically, and a buoyant sphere connected with the second moving member and having a lower density than water, and the first and second moving members may be coupled with each other by a magnet so that the first moving member is moved vertically according to movement of the second moving member which is moved by vertical movement of the buoyant sphere.

The apparatus may further include a subsidiary separator configured to secondarily separate oil contained in filtered water discharged through the drainage unit.

The apparatus may further include a ship in which the separator body is installed to float in an operation area on which the oil is spilled, such that the mixed water is introduced into the separator body from the operation area, and the ship may include a ship body in which the separator body is installed to be floated in the operation area, and a ship propulsion part installed at the ship body to move the ship body.

The separator body may have the mixed water introducing part formed at one side thereof and an oil discharging part formed at an upper portion thereof to discharge oil therethrough, and the ship may be floated in the operation area and may further include a buoyant tank connected with the oil discharging part to receive the oil discharged through the oil discharging part.

The apparatus may further include a supply unit installed at the separator body to supply the mixed water to the separator body, and the supply unit may include a suction pipe configured to suck the mixed water at a position adjacent to a surface of water on which the oil is floated, a suction tank installed at the suction pipe to introduce the mixed water sucked through the suction pipe, a suction impeller configured to discharge internal air of the suction tank to an outer side and thus to reduce an internal pressure of the suction tank, an outlet pipe configured to connect the suction tank with the mixed water introducing part, and first to third valves configured to open and close each connection portion between the suction tank and the suction pipe, between the suction tank and the suction impeller and between the suction tank and the outlet pipe.

The supply unit may include a bypass pipe installed at the suction tank to introduce external air into the suction tank, a water level measuring sensor installed at the suction tank to measure a water level in the suction tank, a fourth valve installed at the bypass pipe to open and close the bypass pipe, and a control part configured to control the fourth valve to open the bypass pipe, such that the external air is introduced into the suction tank, when the water level in the suction tank is higher than a predetermined water level, based on information of the water level measured through the water level measuring sensor.

The supply unit may further include an inlet port floating means installed at an end of the suction pipe to float an inlet port of the suction pipe toward the surface of the water in the operation area.

The inlet port floating means may include a support frame installed at the end of the suction pipe, a buoyant member configured to float on a surface layer of the water or the oil in the operation area, and a rod member configured to support the support frame to be spaced downward from the buoyant member.

The apparatus may further include a filter unit installed at the inlet port side of the first drainage pipe to filter foreign substances contained in the mixed water.

The suction pipe may include a buoyant pipe of which one end is installed at the inlet port floating means so that an inlet port thereof is floated toward the surface of the water in the operation area by the inlet port floating means, a receiving body installed at the other end of the buoyant pipe and having a receiving space therein to receive the mixed water introduced through the buoyant pipe, and a communication pipe of which both ends are connected with a lower portion of the receiving body and the suction tank so as to supply the mixed water received in the receiving body to the suction tank.

The separator body may include a main housing in which the separation space is formed, the mixed water introducing part is provided at a front end thereof, and the drainage unit is installed at a rear end thereof, and an induction unit having a plurality of induction plates installed in the main housing to increase a movement distance of the mixed water introduced into the main housing and thus to increase a period of time in which the mixed water is remained in the main housing.

The induction unit may include a first induction plate of which both ends extend left and right to be in contact with left and right inner walls of the main housing facing each other, and a lower end is in contact with a bottom surface of the main housing, and in which a first water passing hole is formed at a left lower portion thereof to allow the water to pass therethrough, and a second induction plate of which both ends extend left and right to be in contact with left and right inner walls of the main housing facing each other, and a lower end is in contact with the bottom surface of the main housing, and in which a second water passing hole is formed at a right lower portion thereof to allow the water to pass therethrough, and a plurality of first and second induction plates may be alternately arranged in the separation space between the mixed introducing part and the drainage unit in a front and rear direction, such that the mixed water is guided to flow zigzag.

The first and second induction plates may have oil paths formed at upper portions thereof, and the oil paths may be formed to be located higher than a level of the water in the separator body.

The first induction plate may have a first oil passing hole formed at a right upper portion thereof to pass therethrough and thus to provide the oil path, such that the oil passes, and the second induction plate may have a second oil passing holes formed at a left upper portion thereof to pass therethrough and thus to provide the oil path, such that the oil passes.

One end of the oil discharging part may extend from an inner wall of the separator body toward a center of the separator body.

The separator body may have the mixed water introducing part formed at one side thereof and an oil discharging part formed at an upper portion thereof to discharge the oil, and the oil discharging part may include an internal extension pipe of which one end extends to an inner side of the separator body, a subsidiary bellows tube connected and in communication with one end of the internal extension pipe to be vertically expandable and contractible and having an outlet port through which the oil in the separator body is introduced, and a buoyant member installed at the subsidiary bellows tube by a connecting rod and having a lower density than water so that the outlet port is located at an oil layer in the separator body.

The oil discharging part may further include a vertical movement guiding member configured to guide a position of the buoyant member which is moved vertically, and the vertical movement guiding member may be installed in the separator body to have a hollow configured to extend vertically, such that the buoyant member is inserted therein, and a guide hole formed in an outer circumferential surface thereof to extend vertically, such that the connecting rod passes therethrough.

The apparatus may further include a deposit discharging pipe installed at a lower portion of the main housing to be in communication with the separation space and thus to discharge oil deposited on a bottom surface of the main housing to an outer side; a discharge opening/closing valve installed at the deposit discharging pipe to open and close the deposit discharging pipe; an oil detecting sensor installed at a lower inner portion of the main housing to detect the oil deposited on the bottom surface of the main housing; and a control part configured to control the discharge opening/closing valve to open the deposit discharging pipe when the oil is detected through the oil detecting sensor.

The apparatus may further include a deposit discharging pipe installed at a lower portion of the main housing to be in communication with the separation space and thus to discharge oil deposited on a bottom surface of the main housing to an outer side, and an oil heating part configured to heat the oil to reduce a viscosity of the oil, such that the oil is easily discharged through the deposit discharging pipe.

The oil heating part may include an electric heating wire installed at the deposit discharging pipe to generate heat by supplied electric power, and a power supply member configured to supply the electric power to the electric heating wire.

The oil heating part may include at least one microwave generator installed at the deposit discharging pipe to radiate microwaves into the deposit discharging pipe and thus to heat the oil flowing through the deposit discharging pipe.

The oil heating part may include an external case having an installation space to receive the main housing therein, and a steam supply installed at the external case to heat the external case and configured to supply high temperature steam into the installation space.

The ship may include a plurality of subsidiary buoyant members installed at both sides of the ship body to be moved forward and backward in a direction which is gradually far from the ship body and to be floated in the operation area, and a forward and backward driving part configured to move the subsidiary buoyant member forward and backward.

### Advantageous Effects

According to the apparatus for separating and collecting oil spilled in the ocean, since the oil can be separated from the oil due to the density difference between the water and the oil, the apparatus can have a simple structure and can be manufactured at a low cost. In particular, since the apparatus has a structure in which a height of a drainage pipe through which the water is drained can be varied, it is possible to control the water level in the separator body so that the inlet port of the drainage pipe is located at a lower side of the oil layer, and the oil outlet port of the separator body is located at the oil layer, and thus the collection rate of the water can be enhanced.

Further, according to the present invention, the suction device of the mixed water using a vacuum state is provided to minimize the oil generated while the mixed water is sucked, and since the oil absorbing means such as the filter unit and the activated carbon is provided in the separator body to filter the oil, the water can be prevented from being contaminated by the oil, and also the oil-water separating rate of the mixed water can be increased.

According to the present invention, since the ship moved in the operation area is provided, there is an advantage in that it is possible to operate in a wider area. In particular, since the buoyant tank which floats in the operation area and receives the oil therein is installed at the ship, the oil-water separation can be performed for a relatively long period of time in the operation area, and thus the workforce and the cost necessary for the oil-water separation can be reduced.

### DESCRIPTION OF DRAWINGS

FIG. 1 is a perspective view illustrating one embodiment of an apparatus for separating and collecting oil spilled in an ocean according to the present invention.

FIG. 2 is a cross-sectional view of the apparatus for separating and collecting oil spilled in the ocean of FIG. 1.

FIG. 3 is a partially extracted cross-sectional view illustrating another embodiment of a drainage unit.

FIG. 4 is a partially extracted perspective view illustrating another embodiment of the drainage unit having a length adjusting part.

FIG. 5 is a side view illustrating the drainage unit including another embodiment of the length adjusting part.

FIG. 6 is a cross-sectional view of the apparatus for separating and collecting oil spilled in the ocean having the drainage unit which is moved vertically by a buoyant member.

FIG. 7 is a cross-sectional view illustrating another embodiment of an oil discharging part.

FIG. 8 is a partially extracted perspective view illustrating an embodiment in which a vertical movement guiding member is further provided at the oil discharging part of FIG. 7.

FIG. 9 is a partially cut away perspective view illustrating an embodiment of the apparatus for separating and collecting oil spilled in the ocean, in which a mixed water introducing part extends from an upper side of a separator body to a lower side thereof.

FIG. 10 is a cross-sectional view of the apparatus for separating and collecting oil spilled in the ocean of FIG. 9.

FIG. 11 is an exploded perspective view illustrating an embodiment of the drainage unit in which a filter unit is installed.

FIG. 12 is a cross-sectional view illustrating the apparatus for separating and collecting oil spilled in the ocean, which includes the drainage unit having the filter unit of FIG. 11.

FIG. 13 is a perspective view illustrating the apparatus for separating and collecting oil spilled in the ocean, which further includes a subsidiary separator.

FIG. 14 is a conceptual view illustrating one embodiment of a supply unit for supplying the mixed water to the separator body.

FIG. 15 is an extracted perspective view of an inlet port floating means which floats an end of a suction pipe for sucking the mixed water to be near a surface of the water.

FIG. 16 is a perspective view illustrating an unmanned ship in which the apparatus for separating and collecting oil spilled in the ocean according to one embodiment of the present invention is installed.

FIG. 17 is a cross-sectional view of a suction pipe according to still another embodiment of the present invention.

FIG. 18 is a perspective view of a separator body according to still another embodiment of the present invention.

FIGS. 19 and 20 are cross-sectional views of the separator body of FIG. 18.

FIG. 21 is a cross-sectional view of an oil discharging part according to still another embodiment of the present invention.

FIG. 22 is a cross-sectional view of an apparatus for separating and collecting oil spilled in the ocean according to still another embodiment of the present invention.

FIG. 23 is a cross-sectional view of an apparatus for separating and collecting oil spilled in the ocean according to yet another embodiment of the present invention.

FIG. 24 is a cross-sectional view of an apparatus for separating and collecting oil spilled in the ocean according to yet another embodiment of the present invention.

FIG. 25 is a cross-sectional view of an apparatus for separating and collecting oil spilled in the ocean according to yet another embodiment of the present invention.

FIG. 26 is a perspective view of a ship according to still another embodiment of the present invention.

### MODES OF THE INVENTION

Hereinafter, exemplary embodiments of the present invention will be described in detail with reference to the accompanying drawings.

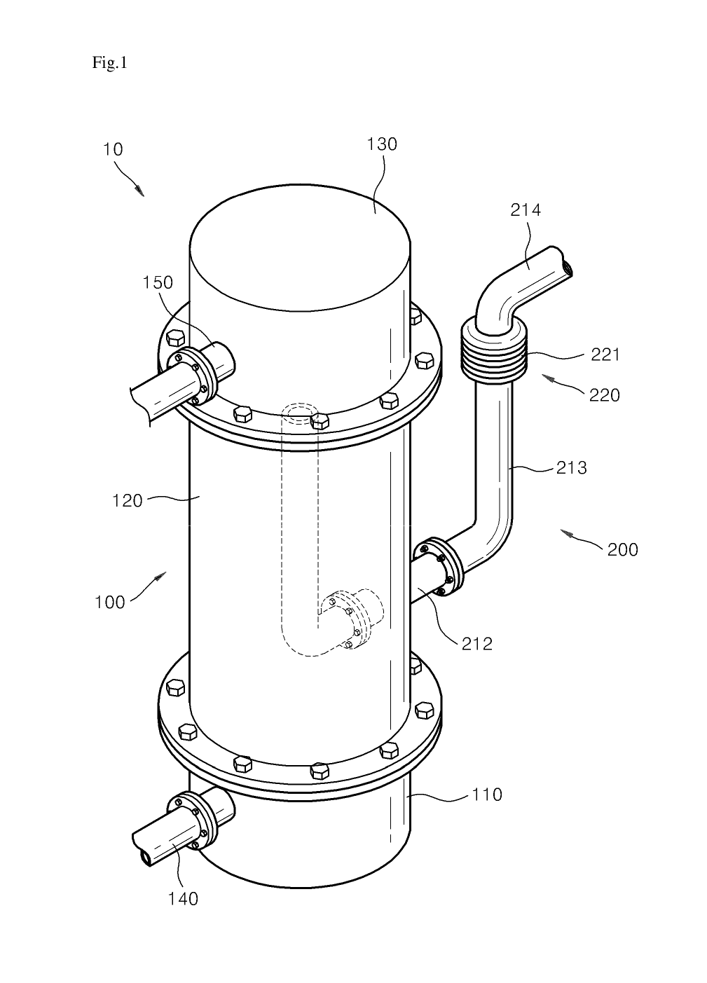

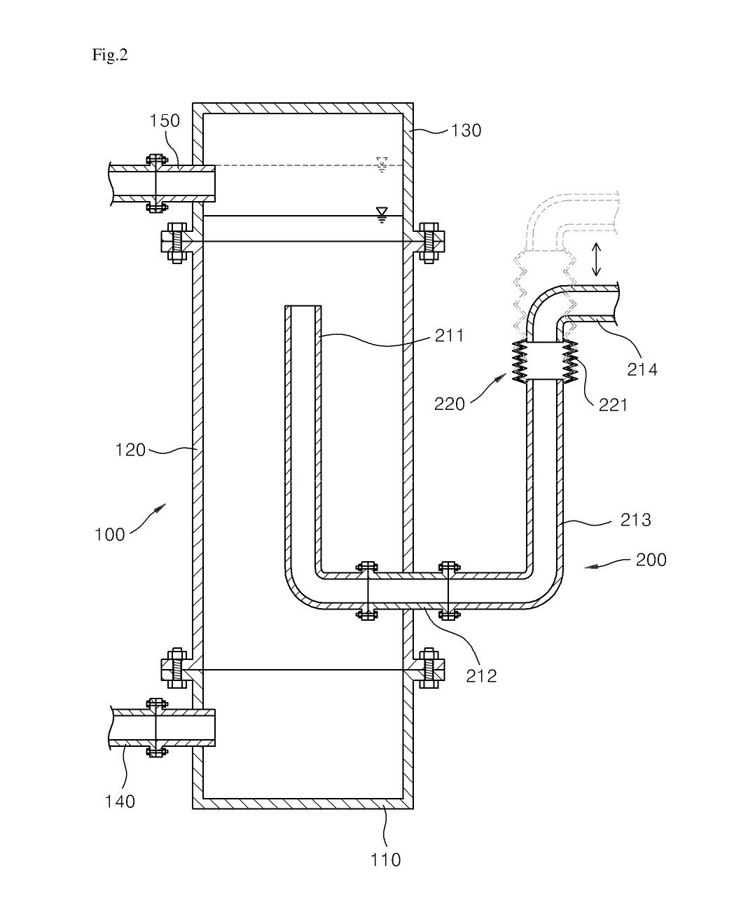

FIGS. 1 and 2 illustrate one preferred embodiment of an apparatus 100 for separating and collecting oil spilled in an ocean according to the present invention.

Referring to the drawings, the apparatus 100 for separating and collecting oil spilled in the ocean includes a separator body 100 having an oil-mixed water introducing part 140 and an oil discharging part 150, and a drainage unit 200 through which filtered water from which oil is separated in the separator body 100 is discharged.

The separator body 100 is formed into a cylindrical member having an internal space serving as a separation space in which the oil is separated from the water. In the case of the embodiment, the separator body 100 is formed in three bodies including a lower body 110, a middle body 120 and an upper body 130 which are coupled with each other.

The lower body 110 is located at the lowermost portion of the separator body 100, and a flange for connection with the middle body 120 is formed at an upper end thereof. The mixed water introducing part 140 is formed at the lower body 110 so that the mixed water in which the water and the oil are mixed is introduced. The middle body 120 is formed as a cylindrical member to have a flange formed at each of upper and lower ends thereof and a through hole formed at one side thereof so that a drainage pipe of the drainage unit 200 passes therethrough. The upper body 130 is flange-coupled to the upper end of the middle body 120 and has the oil discharging part 150 so that the separated oil is discharged therethrough.

Each of the mixed water introducing part 140 and the oil discharging part 150 is connected with a transfer pipe, and thus the mixed water in which the water and the oil are mixed or the oil separated from the water in the separator body 100 may flow through the transfer pipe.

As illustrated in the drawings, since the mixed water introducing part 140 through which the mixed water is introduced is formed at the lower body 110, and the oil discharging part 150 through which the oil is discharged is formed at the upper body 130, the mixed water is introduced through a lower portion of the separator body 100, and the separated oil is discharged through an upper portion of the separator body 100.

When the mixed water in which the water and the oil are mixed is introduced through the mixed water introducing part 140, the oil moves up above the surface of the water due to a density difference between the oil and the water, while the mixed water is filled in the internal space of the separator body 100, and thus the oil is separated from the water in the separator body 100.

In the embodiment, the separator body 100 includes the three bodies of the lower body 110, the middle body 120 and the upper body 130 which are flange-coupled with each other. However, unlike the embodiment, the separator body 100 may be formed to have the internal space defined by two members, and also an exterior of the separator body 100 is not limited to the cylindrical shape of the embodiment, but may be formed in various prismatic shapes.

The drainage unit 200 serves to discharge the water, from which the oil is separated in the separator body 100, to an outer side of the separator body 100. The drainage unit 200 includes a drainage member having a first drainage pipe 211 located in the separator body 100 to extend vertically at a predetermined length, a second drainage pipe 212 connected with a lower end of the first drainage pipe 211 to horizontally pass through the separator body 100 and to extend to an outer side of the separator body 100, a third drainage pipe 213 configured to extend upward from an end of the second drainage pipe 212, and a fourth drainage pipe 214 connected with an upper end of the third drainage pipe 213 to be horizontal or inclined downward, and a length adjusting part 220 formed at the third drainage pipe 213 exposed to the outer side of the separator body 100 so as to adjust a height of the upper end of the third drainage pipe 213.

The first, second and third drainage pipes 211, 212 and 213 are generally formed in a U shape. The water is introduced through an inlet port formed at an upper end of the first drainage pipe 211, passes sequentially through the second, third and fourth drainage pipes 212, 213 and 214, and then is drained.

The length adjusting part 220 serves to control a water level in the separator body 100.

The draining of the water through the drainage unit 200 is achieved in a natural drainage manner in which the water is automatically introduced through the inlet port of the first drainage pipe 211 without an external force and then drained. Therefore, the water may be drained only when the water level in the separator body 100 is higher than the height of the upper end of the third drainage pipe 213.

However, a thickness of an oil layer in the separator body 100 is changed according to an oil content contained in the mixed water introduced into the separator body 100 for oil-water separation. That is, when the oil content is high, the thickness of the oil layer is increased, and when the oil content is low, the thickness thereof is reduced.

Since a position of the oil discharging part 150 is fixed, the oil may be easily discharged through the oil discharging part 150 by controlling the water level in the separator body 100, and thus efficiency in the oil-water separation is increased. Accordingly, the water level in the separator body 100 is controlled by the length adjusting part 220.

The length adjusting part 220 of the embodiment is formed into a bellows tube 221 formed at an upper portion of the third drainage pipe 213. A length of the length adjusting part 220 of the embodiment may be stretchably adjusted by the bellows tube 221. When the bellows tube 221 is expanded, a position of the upper end of the third drainage pipe 213 is moved up, and thus the water level rises, and when the bellows tube 221 is contracted, a length of the bellows tube 221 is shortened, and the position of the upper end of the third drainage pipe 213 is moved down, and thus the water level is lowered.

A height of the upper end of the third drainage pipe 213 controlled by the length adjusting part 220 is preferably limited to between the inlet port of the upper end of the first drainage pipe 211 and an outlet port of the oil discharging part 150. Although not illustrated, a state in which the position of the upper end of the third drainage pipe 213 is controlled by the length adjusting part 220 is maintained by a separate supporting means for supporting the fourth drainage pipe 214.

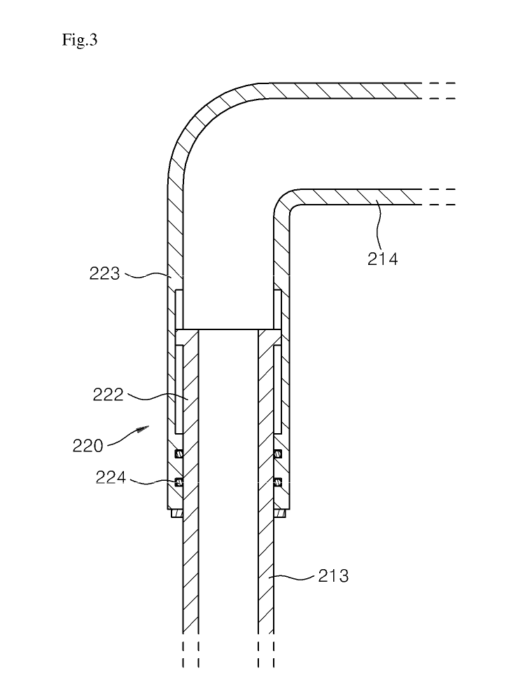

FIG. 3 illustrates another embodiment of the length adjusting part 220.

As illustrated in the drawing, the length adjusting part 220 of the embodiment includes an internal pipe 222 formed at the upper end of the third drainage pipe 213 to extend upward, an external pipe 223 formed to surround an outer circumferential surface of the internal pipe 222 and connected with the fourth drainage pipe 214, and a sealing member 224 installed at an inner circumferential surface of the external pipe 223 to prevent the water from leaking between the internal pipe 222 and the external pipe 223.

As illustrated in the drawing, since the external pipe 223 is installed to be moved vertically with respect the internal pipe 222, when the external pipe 223 is moved up, a height of a connection part 241 connected with the fourth drainage pipe 214 rises, and when the external pipe 223 is moved down, the height of the connection part 241 connected with the fourth drainage pipe 214 is lowered. Therefore, the water level in the separator body 100 may be controlled.

In addition, a stopper which supports a lower end of the external pipe 223 and restricts downward movement of the external pipe 223 is preferably formed at a lower end of the internal pipe 222.

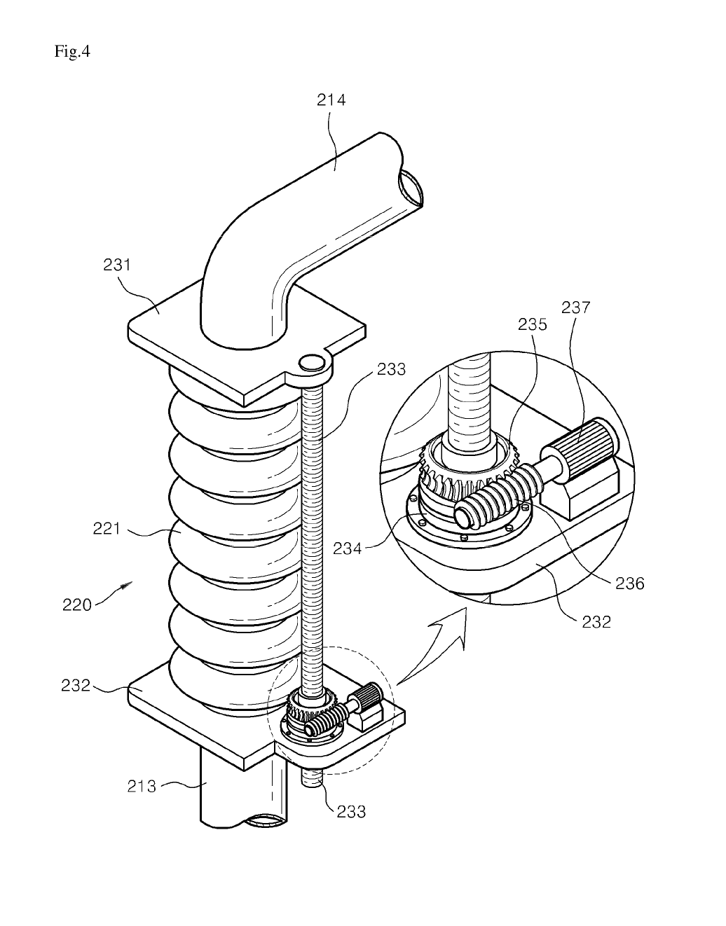

FIG. 4 illustrates still another embodiment of the length adjusting part 220. The length adjusting part 220 in the embodiment is configured to control the height of the upper end of the third drainage pipe 213 in a motor-operated manner.

The length adjusting part 220 in the embodiment includes a bellows tube 221 configured to stretchably form a partial section of the third drainage pipe 213, upper and lower panels 231 and 232 installed at upper and lower ends of the bellows tube 221, respectively, a screw member 233 configured to extend downward from the upper panel 231 so as to pass through the lower panel 232, a worm wheel member 235 rotatably supported by the lower panel 232 via a thrust bearing 234 and having a hollow through which the screw member 233 passes, a worm 236 engaged with the worm wheel member 235, and a driving motor 237 configured to rotate the worm 236.

The worm wheel member 235 has a screw thread formed on an inner circumferential surface of the hollow to be screwed with the screw member 233. When the driving motor 237 is operated, the worm 236 rotates the worm wheel member 235. Since the worm wheel member 235 is supported by the lower panel 232 via the thrust bearing 234, when the worm wheel member 235 is rotated, the screw member 233 screwed with the worm wheel member 235 is moved vertically, and the upper panel 231 connected with the screw member 233 is also moved vertically with the screw member 233 to expand or contract the bellows tube 221 and thus to adjust a length of the bellows tube 221.

In the embodiment, a screw type actuator is used to adjust the length of the bellows tube 221. Alternatively, an actuator such as a pneumatic cylinder or a hydraulic cylinder may be used.

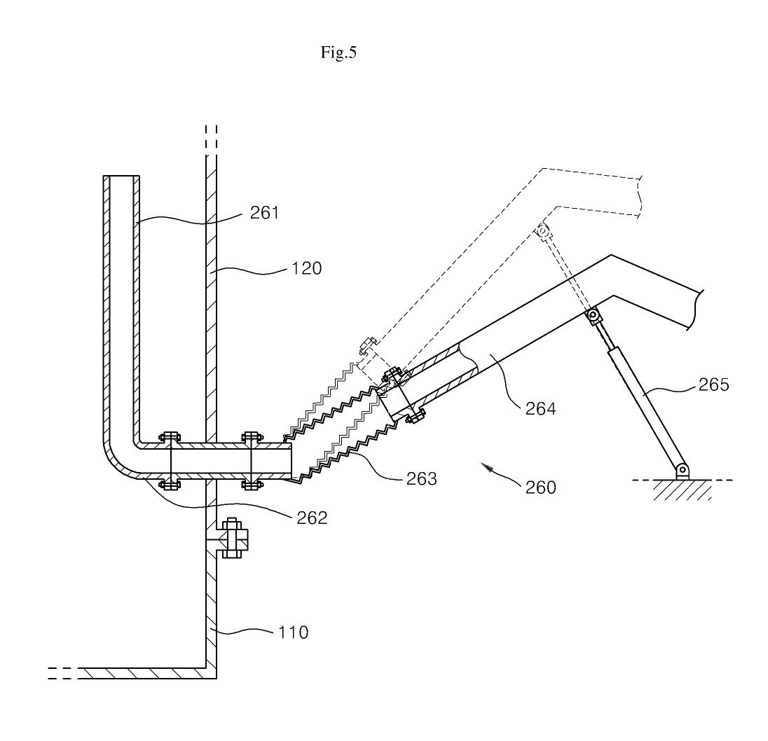

FIG. 5 illustrates still another embodiment of the drainage unit 260.

In the drainage unit 260 of the embodiment, a first drainage pipe 261 is formed in the separator body 100, a second drainage pipe 262 is formed at a lower end of the first drainage pipe 261 to pass through the separator body 100, a flexible tube 263 is connected with an end of the second drainage pipe 262, and a third drainage pipe 264 is connected with an end of the flexible tube 263. Further, an actuator 265 which pivots an upper end of the third drainage pipe 264 vertically is connected with the third drainage pipe 264.

The flexible tube 263 is a stretchable tube which allows an inclined angle of the third drainage pipe 264 to be adjusted with respect to the second drainage pipe 262, and the third drainage pipe 264 may be configured to be pivoted vertically about a lower portion thereof connected with the flexible tube 263 by the actuator 265, and a height of an upper end of the third drainage pipe 264 is controlled by the pivoting of the third drainage pipe 264.

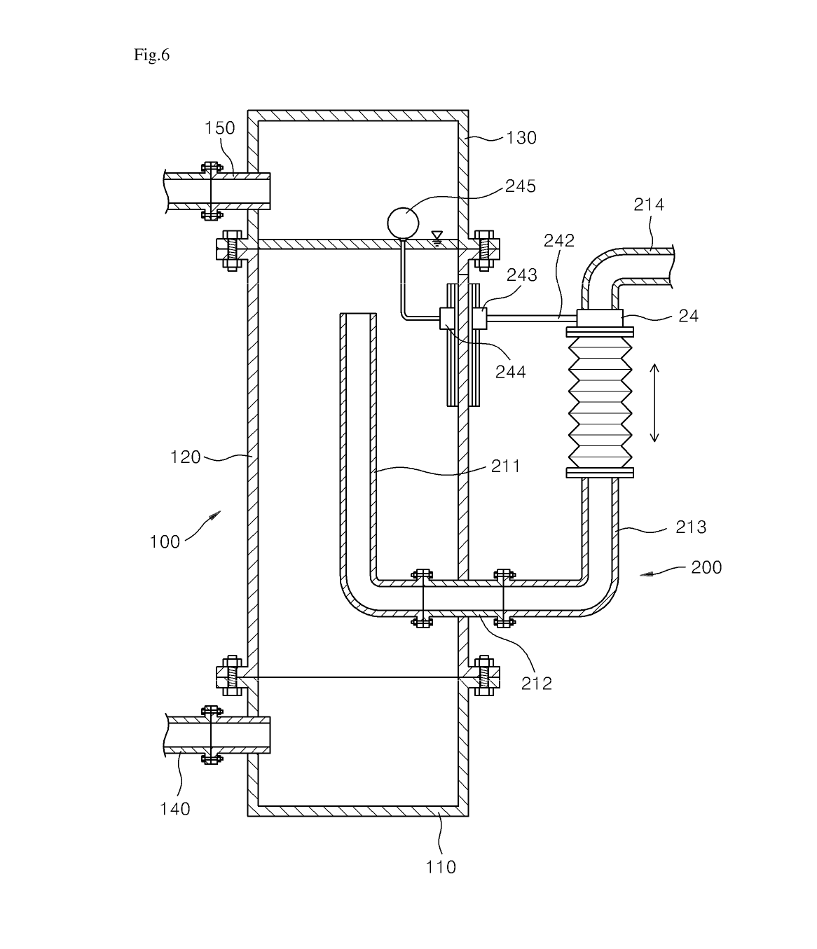

FIG. 6 illustrates another embodiment of the drainage unit 200 including the length adjusting part 220 having a buoyant sphere 245.

The length adjusting part 220 of the embodiment includes a bellows tube 221 stretchably formed at the third drainage pipe 213, a connection part 241 installed at an upper side of the bellows tube 221, a connection rod 242 configured to extend from the connection part 241 toward the separator body 100, a first moving member 243 installed at an end of the connection rod 242 to be moved vertically along the separator body 100, a second moving member 244 located in the separator body 100 to be connected with the first moving member 243 by a magnetic force and thus to be moved vertically with the first moving member 243, and the buoyant sphere 245 connected with the second moving member 244 to float on a surface of the water.

The buoyant sphere 245 is formed to have a smaller density than the water and thus to float on the oil layer. When the water is introduced into the separator body 100 and the level of the water is increased, the buoyant sphere 245 is moved up, and the second moving member 244 connected with the buoyant sphere 245 is also moved up along a guide rail.

Since the first moving member 243 is connected with the second moving member 244 by the magnetic force, when the second moving member 244 is moved vertically by the buoyant sphere 245 according to the level of the water, the first moving member 243 is moved vertically to correspond to the second moving member 244. When the first moving member 243 is moved vertically, the connection part 241 installed at the third drainage pipe 213 by the connection rod 242 is moved vertically with the first moving member 243, and thus a length of the bellows tube 221 is changed.

In the drainage unit 200 of the embodiment, since a position of the upper end of the third drainage pipe 213 is changed according to the level of the water, the water may not be discharged through the oil discharging part 150, and the separated oil may be easily discharged through the oil discharging part 150.

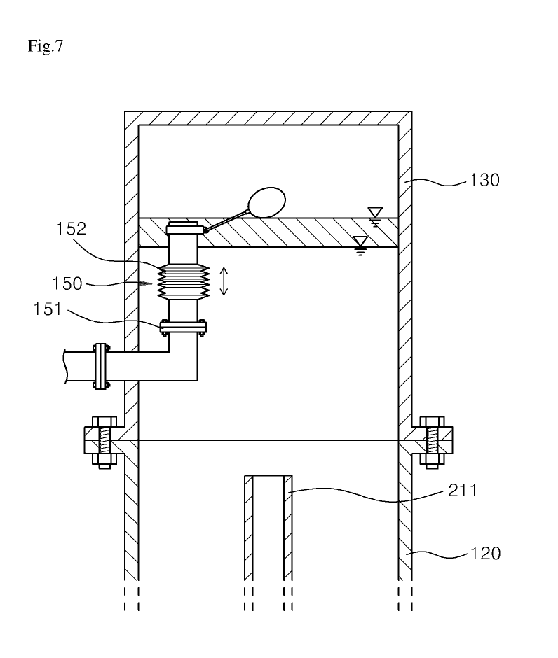

FIG. 7 illustrates another embodiment of the oil discharging part 150.

The oil discharging part 150 of the embodiment includes an internal extension pipe 151 configured to extend to an inner side of the separator body 100, and a subsidiary bellows tube 152 provided at one end of the internal extension pipe 151 so that a length thereof is stretchably changed vertically, and thus a height of an outlet port for oil discharged through the oil discharging part 150 may be changed. An upper portion of the subsidiary bellows tube 152 is connected with a buoyant member 153 via a connecting rod 156, and the buoyant member 153 is formed to have a smaller density than water and thus to be located at the oil layer. Since the buoyant member 153 is always located at the oil layer, the outlet port of the upper end of the subsidiary bellows tube 152 connected with the buoyant member 153 is always located at the oil layer so that only the oil is discharged.

A length of the oil discharging part 150 of the embodiment is automatically controlled so that the outlet port of the upper end of the internal extension pipe 151 is always exposed to the oil layer, and thus the oil-water separation is effectively achieved.

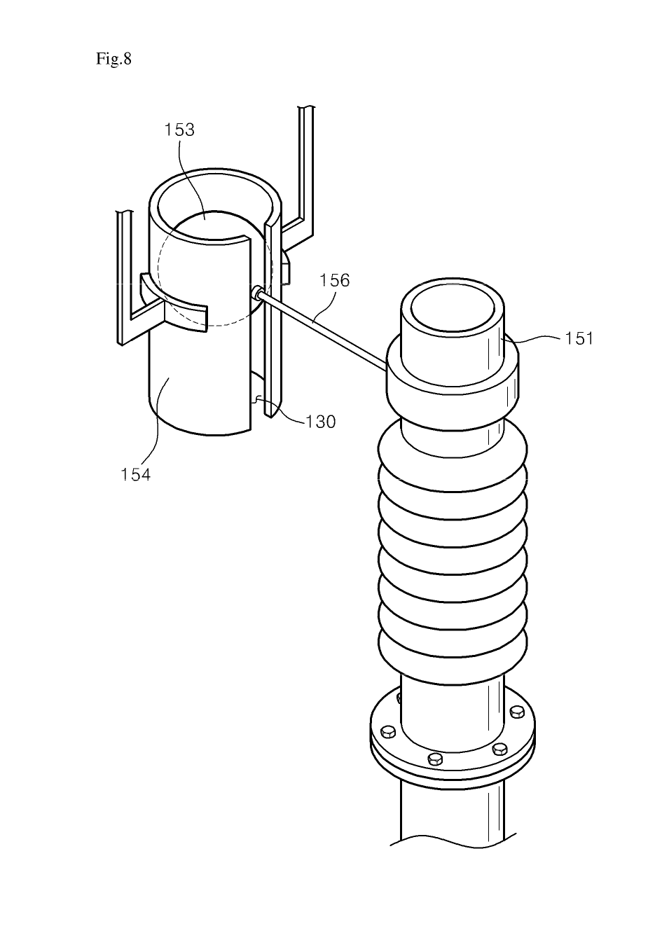

As illustrated in FIG. 8, the oil discharging part 150 of the embodiment may further include a vertical movement guiding member 154 configured to guide a position of the buoyant member 153 which is moved vertically.

The vertical movement guiding member 154 is formed into a hollow cylindrical body having an inner diameter corresponding to a diameter of the buoyant member 153 and formed at an inner upper side of the separator body 100 to extend upward. A guide hole 155 formed to extend vertically, such that the connecting rod 156 connecting the buoyant member 153 with the subsidiary bellows tube 152 passes therethrough, is formed at one side of the vertical movement guiding member 154.

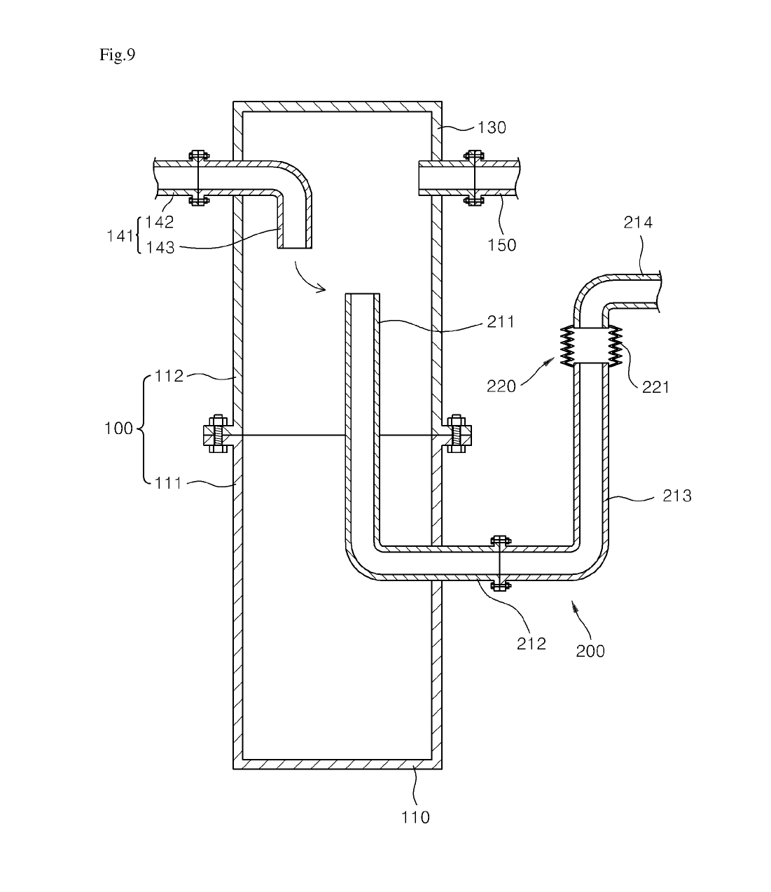

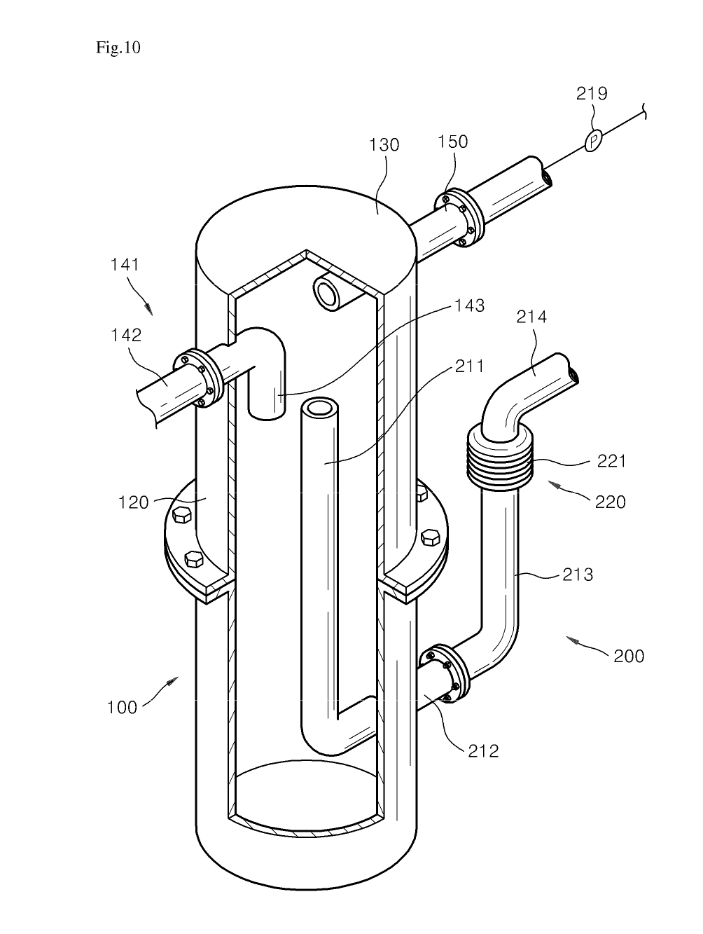

Referring to FIGS. 9 and 10, in the apparatus 10 for separating and collecting oil spilled in the ocean, the separator body 100 may include first and second bodies 111 and 112 which are coupled and separated vertically. The mixed water introducing part 141 and the oil discharging part 150 may be formed to be connected with an upper portion of the separator body 100.

The separator body 100 of the embodiment has a simple structure in which the first and second bodies 111 and 112 are easily separated and coupled by flange coupling. The mixed water introducing part 141 through which the mixed water is introduced includes a first extension pipe 142 connected to an upper portion of the second body 112, and a second extension pipe 143 configured to extend downward from an end of the first extension pipe 142 inserted into the separator body 100. At this time, the second extension pipe 143 preferably extends so that a lower end thereof is located higher than the fourth drainage pipe 214. Since the lower end of the second extension pipe 143 is located higher than the fourth drainage pipe 214, and thus located higher than the level of the water in the separator body 100, the oil of the mixed water discharged through the second extension pipe 143 is prevented from remaining in the second extension pipe 143.

The drainage unit 200 and the oil discharging part 150 of the embodiment are the same as in the embodiments of the apparatus 10 for separating and collecting oil spilled in the ocean illustrated in FIGS. 1 and 2, and thus detailed description thereof will be omitted.

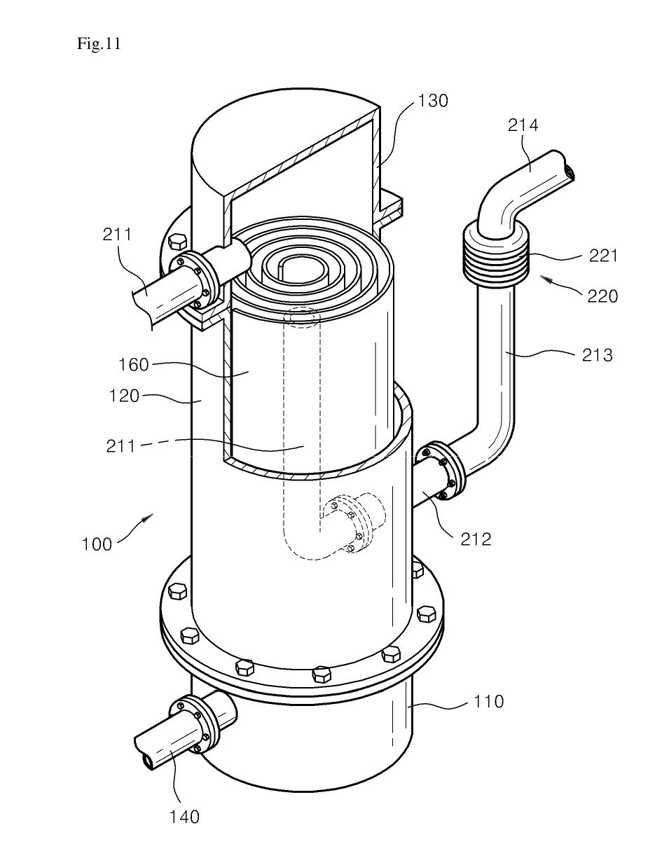

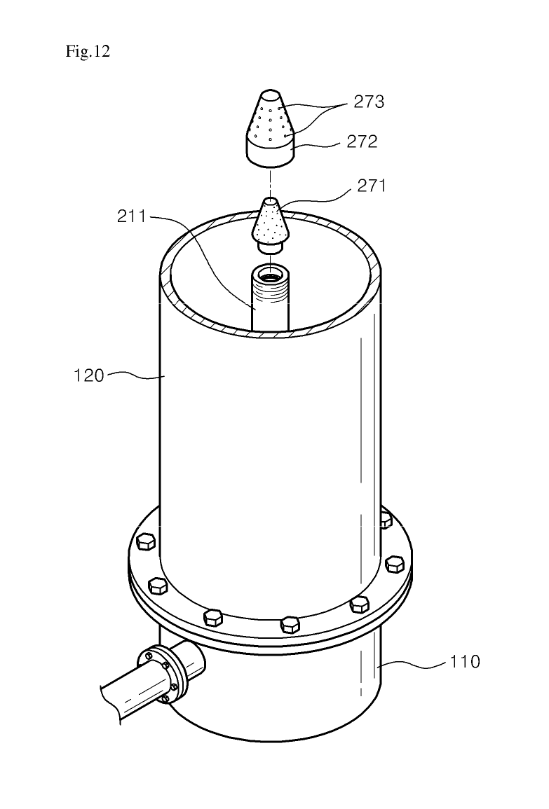

FIGS. 11 and 12 illustrate an embodiment in which a filter unit is installed at an inlet port side of the first drainage pipe 211.

Referring to the drawings, the filter unit includes a filter 271 and a cover member 272.

The filter 271 serves to filter various foreign substances such as oil. As illustrated in the drawing, a cone-shaped cover member 272 is installed at the upper portion of the first drainage pipe 211, and the filter 271 corresponding to an internal shape of the cover member 272 is installed.

The cover member 272 has a plurality of through-holes 273 through which the water may be introduced. Since the filter 271 is formed to correspond to the cone-shaped cover member 272, a surface area thereof is increased, compared with a case in which the filter is formed in a shape corresponding to a cross-sectional area of the first drainage pipe 211, and thus filtered water may be more easily introduced.

Like the above-mentioned embodiments, the drainage unit 200 may be formed so that natural drainage is achieved by a water pressure. However, as illustrated in FIG. 10, a separate drainage pump or impeller which sucks and forcibly discharges the water in the separator body 100 may be installed at the third drainage pipe 213. The drainage pump 219 or the impeller may be installed at various positions other than the third drainage pipe 213.

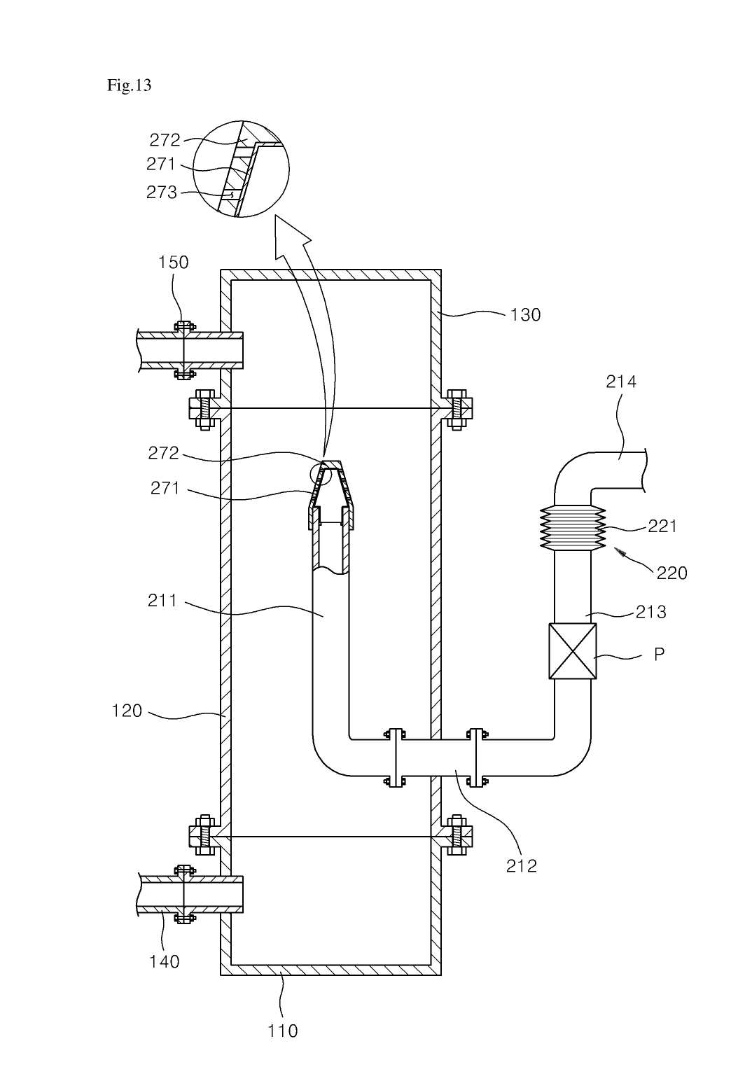

As illustrated in FIG. 13, the apparatus 10 for separating and collecting oil spilled in the ocean may further include a subsidiary separator 300.

After the oil-water separation is primarily performed in the separator body 100 due to the density difference between the water and the oil, the filtered water is drained through the drainage unit 200 to the outer side of the separator body 100. However, it is difficult to perform the complete oil-water separation in the separator body 100, and the oil may partially remain in the filtered water. The subsidiary separator 300 serves to remove even such small amounts of the oil, and includes an external housing 330 having an internal space, an internal housing 340 installed in the external housing 330, an oil collecting part 350 rotatably installed in the internal housing 340, and a rotation driving part 360 configured to rotate the oil collecting part 350.

The external housing 330 is formed in a cylindrical shape with the internal space, and the internal housing 340 is formed in the external housing 330 to have a cone shape. That is, the internal housing 340 is formed so that inner and outer diameters thereof are gradually reduced from a bottom of the external housing 330 toward an upper side thereof, and an upper end of the internal housing 340 is opened so that the internal space of the external housing 330 is in communication with an internal space of the internal housing 340.

Meanwhile, the external housing 330 has a subsidiary discharging pipe 335 formed at an upper portion thereof so that the oil separated therein may be discharged therethrough. The oil separated from the water introduced into the external housing 330 due to the density difference is discharged to an outer side of the external housing 330 through the subsidiary discharging pipe 335.

The oil collecting part 350 includes a rotating shaft 351 configured to rotatably extend upward from an internal center of the internal housing 340, a spiral extension member 352 supported by the rotating shaft 351 and configured to spirally extend along the rotating shaft 351 from an upper portion of the rotating shaft 351 to a lower portion thereof, and a plurality of brush members 353 provided at the spiral extension member 352.

The spiral extension member 352 is formed in a spiral shape of which a diameter is gradually increased downward to correspond to the inner diameter of the internal housing 340. A plurality of supporting rods 354 connect the spiral extension member 352 with the rotating shaft 351 so that the spiral extension member 352 is connected with the rotating shaft 351 to be rotated together. The brush members 353 are formed along a length of the extension member 352, so that the oil contained in the filtered water introduced into the internal housing 340 is attached to the brush members 353 and removed.

The rotation driving part 360 includes a rotating motor 361 which rotates the rotating shaft 351 exposed to an outer side of the external housing 330. Although covered by a case 362 and not illustrated in the drawing, a lower end of the rotating shaft 351 is connected with the rotating motor 361 via a gear which transmits a rotating force.

In the subsidiary separator 300 of the embodiment, the filtered water discharged after the oil-water separation is primarily performed in the separator body 100 passes through the external housing 330 and the internal housing 340 via an injection pipe and is introduced into the internal space of the internal housing 340. Then, while the filtered water is moved to the external housing 330 through the through-hole 273, the oil is attached to the brush members 353 of the oil collecting part 350, and thus the oil-water separation is performed. The filtered water from which the oil is removed is discharged to the external housing 330 through the through-hole 273 and then drained.

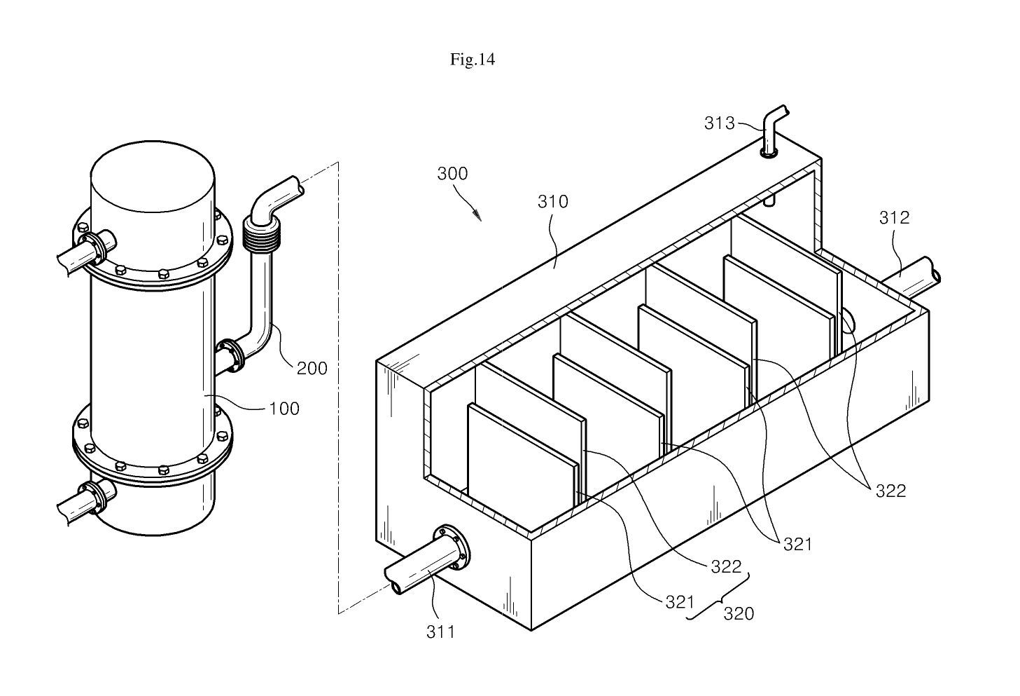

FIG. 14 schematically illustrates one embodiment of a supply unit 500 for supplying the mixed water, in which the oil is mixed with the water, into the separator body 100.

The supply unit 500 includes a suction pipe 510 configured to suck the mixed water at a position adjacent to the surface of the water on which the oil is located, a suction tank 520 in which the water sucked through the suction pipe 510 is introduced, a suction impeller 530 configured to discharge internal air of the suction tank 520 to an outer side and thus to reduce an internal pressure of the suction tank 520, an outlet pipe 540 configured to connect the suction tank 520 with the mixed water introducing part 140, and first to third valves 551 to 553 configured to open and close each connection portion between the suction tank 520 and the suction pipe 510, between the suction tank 520 and the suction impeller 530 and between the suction tank 520 and the outlet pipe 540.

A process in which the mixed water is supplied to the separator body 100 through the supply unit 500 is as follows. First, in a state in which the third valve 553 is closed and the first and second valves 551 and 552 are opened, when the suction impeller 530 is operated, the internal air of the suction tank 520 is discharged, and the internal pressure is reduced, and thus the mixed water is introduced into the suction tank 520 through the suction pipe 510.

When the mixed water is filled in the suction tank 520, the operation of the suction impeller 530 is stopped, the third valve 553 is opened, and the mixed water in the suction tank 520 is discharged to the separator body 100 through the outlet pipe 540. When the mixed water is discharged from the suction tank 520 to the separator body 100, the suction tank 520 is preferably located higher than the separator body 100 so that the mixed water is automatically discharged using potential energy.

Preferably, a check valve is used as the first valve 551 to prevent the mixed water introduced into the suction tank 520 from being discharged to the suction pipe 510. Further, the check valve is preferably used as the third valve 553 to prevent the mixed water in the outlet pipe 540 from flowing backward to the suction tank 520 side.

Meanwhile, the supply unit 500 further includes a bypass pipe 571 installed at the suction tank 520 to introduce external air into the suction tank 520, a water level measuring sensor 573 installed at the suction tank 520 to measure an internal water level of the suction tank 520, a fourth valve 572 installed at the bypass pipe 571 to open and close the bypass pipe 571, and a control part 574 configured to control the fourth valve 572 to open the bypass pipe 571, such that the external air is introduced into the suction tank 520 when the water level in the suction tank is higher than a predetermined water level based on information of the water level measured through the water level measuring sensor 573. At this time, the control part 574 controls the internal pressure of the suction tank 520 to prevent the suction tank 520 from being damaged or malfunctioning due to the pressure.

Further, although not illustrated in the drawings, the supply unit 500 may include a plurality of suction tanks 520 connected with the suction impeller 530. When the mixed water in one of the suction tanks 520 arrives at the predetermined water level, a pipe connected with the suction impeller 530 is blocked by the fourth valve 572, and the mixed water is introduced into the other suction tank 520 and then introduced into the separator body, and thus the mixed water may be continuously introduced into the separator body 100, and the suction impeller 530 may be continuously operated without being stopped.

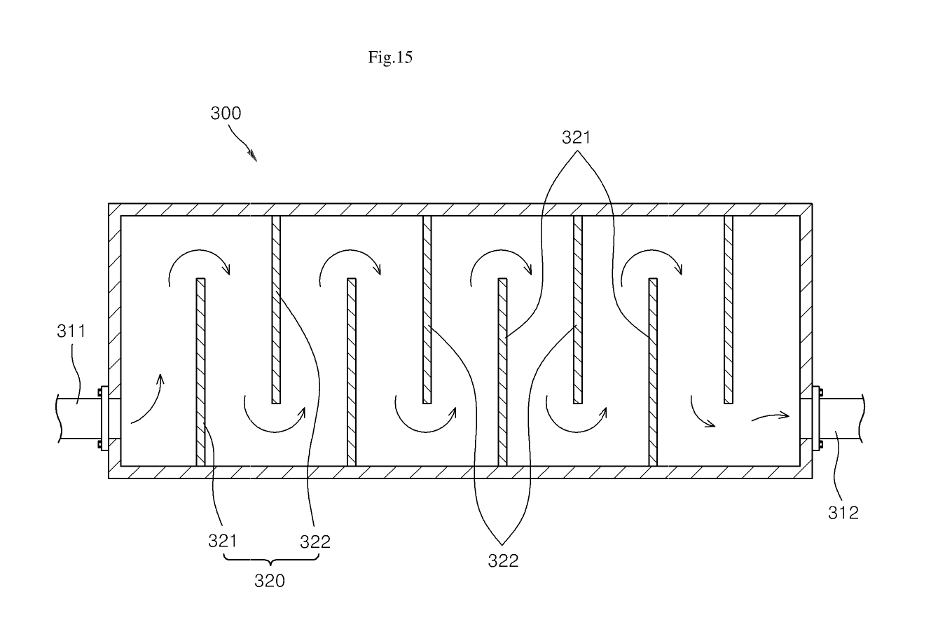

As illustrated in FIG. 15, an inlet port floating means 560 for floating an inlet port of the suction pipe 510 toward the surface of the water may be further provided at an end of the suction pipe 510.

The inlet port floating means 560 includes a support frame 562 installed at the end of the suction pipe 510, a buoyant member 561 capable of floating on a surface layer of the water or the oil, and a rod member 563 configured to connect the buoyant member 561 with the support frame 562.

The rod member 563 has a screw thread, and a link 564 in which the rod member 563 is inserted is formed at an end of the support frame 562, and thus the rod member 563 is coupled so as to pass through the link 564 of the support frame 562. First and second nuts 565 and 566 are provided at upper and lower portions of the link 564, respectively. The first and second nuts 565 and 566 have screw directions opposite to each other, and a connection position between the rod member 563 and the link 564 may be controlled by releasing or fastening the first and second nuts 565 and 566. Therefore, a distance between the support frame 562 and the buoyant member 561 may be controlled.

When a thickness of the oil layer is thick, the distance between the support frame 562 and the buoyant member 561 is controlled to be increased, and when the thickness of the oil layer is thin, the distance between the support frame 562 and the buoyant member 561 is controlled to be reduced, and thus the oil on the surface of the water may be easily sucked.

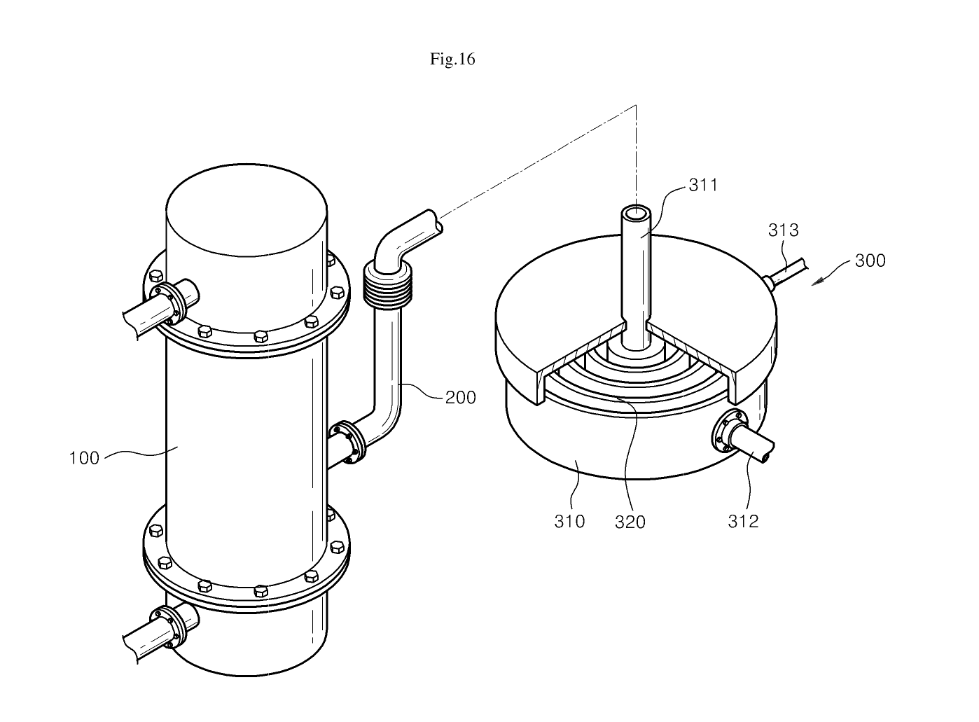

As illustrated in FIG. 16, the apparatus 100 for separating and collecting oil spilled in the ocean of the present invention, as described above, may be installed in a ship 400 and may perform the oil-water separation on a lake, a reservoir or an ocean in which the oil is spilled.

The ship 400 includes a ship body 410 in which the separator body 100 is installed, and a ship propulsion part 420 which moves the ship body 410. The mixed water in which the oil and the water are mixed is sucked into the separator body 100 installed at the ship body 410 through a pipe entering the water, and then the oil is separated, and the filtered water from which the oil is separated is transported to a subsidiary separator 300 connected with the ship body 410, and the oil-water separation is performed once more, and then the filtered water is discharged. Meanwhile, the ship propulsion part 420 may be operated by an operator who boards the ship body 410, may be automatically operated according to a predetermined route, or may be operated by a radio controller.

The subsidiary separator 300 illustrated in the embodiment is the same as the subsidiary separator 300 of the embodiment illustrated in FIG. 13, and installation of the subsidiary separator 300 may be omitted.

Meanwhile, a buoyant tank may be installed at the ship body 410 to receive the oil separated from the mixed water, instead of the subsidiary separator 300. Although not illustrated in the drawings, the buoyant tank may have a buoyant space to generate a buoyancy force. Further, the buoyant tank is connected with the oil discharging part 150 to receive the oil therein. The buoyant tank connected with the ship body 410 may be moved to waters far from land by an unmanned ship.

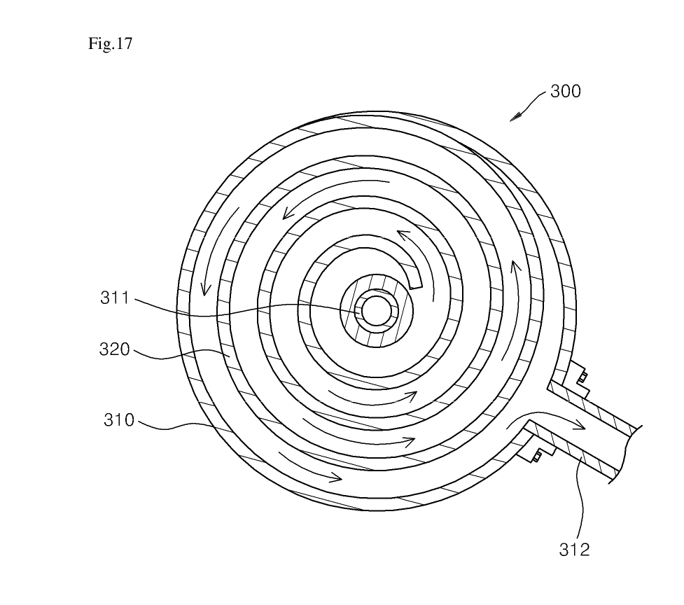

Meanwhile, FIG. 17 illustrates a suction pipe 610 according to still another embodiment of the present invention.

Referring to the drawing, the suction pipe 610 includes a buoyant pipe 610 of which one end is installed at the inlet port floating means so that an inlet port thereof floats toward the surface of the water in an operation area by the inlet port floating means, a receiving body 620 installed at the other end of the buoyant pipe 610 and having a receiving space therein to receive the mixed water introduced through the buoyant pipe 610, and a communication pipe 630 of which both ends are connected with a side surface of the receiving body 620 and the suction tank so as to supply the mixed water received in the receiving body 620 to the suction tank.

The support frame 562 is installed at one end of the buoyant pipe 610 and floats on a surface layer of the water or the oil due to the buoyant members 561. At this time, since the buoyant pipe 610 is installed to be directed toward the surface of the water in the operation area, the mixed water in the operation area is introduced through the buoyant pipe 610.

The receiving body 620 is formed to have a larger cross-sectional area than of the buoyant pipe 610. In the illustrated embodiment, the receiving body 620 is formed to have a rectangular cross section. However, the receiving body 620 is not limited to the illustrated embodiment, but may have a circular shape or an elliptical shape.

The mixed water introduced through the buoyant pipe 610 is received in the receiving body 620, and the communication pipe 630 is connected with a lower portion of the receiving body 620. Therefore, since an end of the communication pipe 630 is maintained to always be submerged in the mixed water received in the receiving body 620, air is prevented from being introduced through the communication pipe 630 even when big waves rise in the operation area, and thus the internal pressure of the suction tank 520 is lowered, and the mixed water is prevented from leaking to the outlet pipe 540.

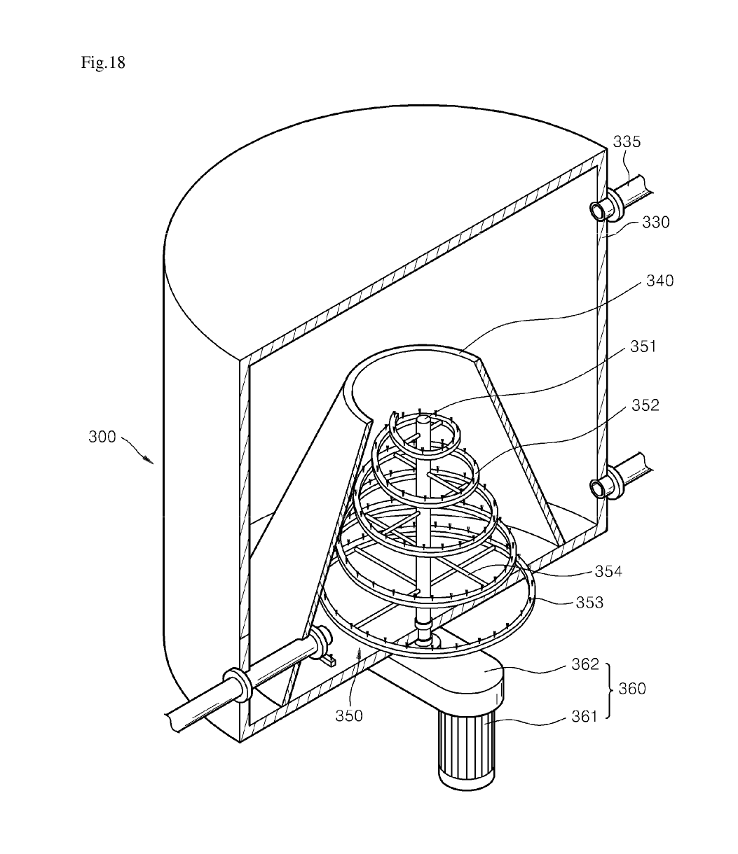

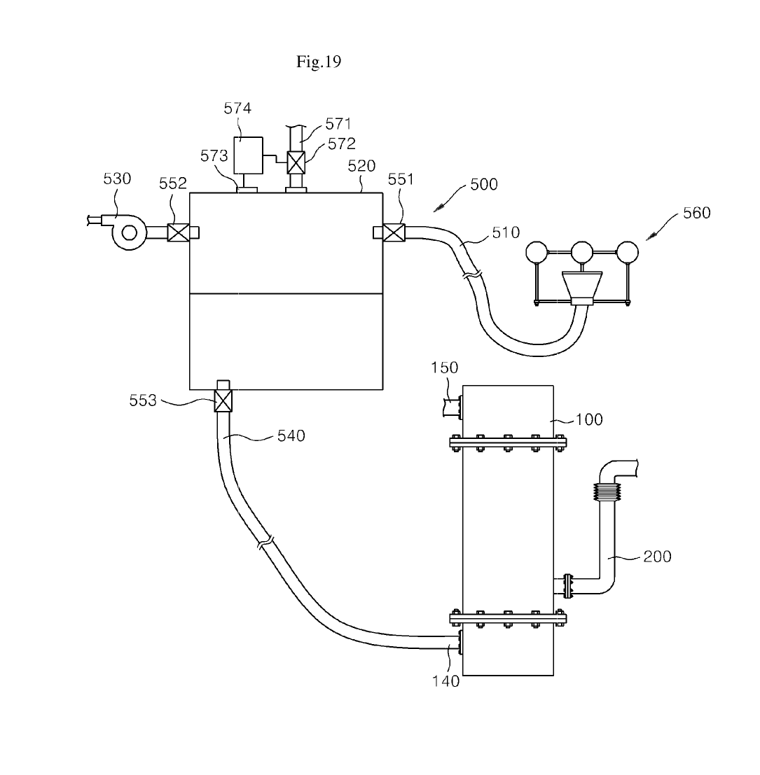

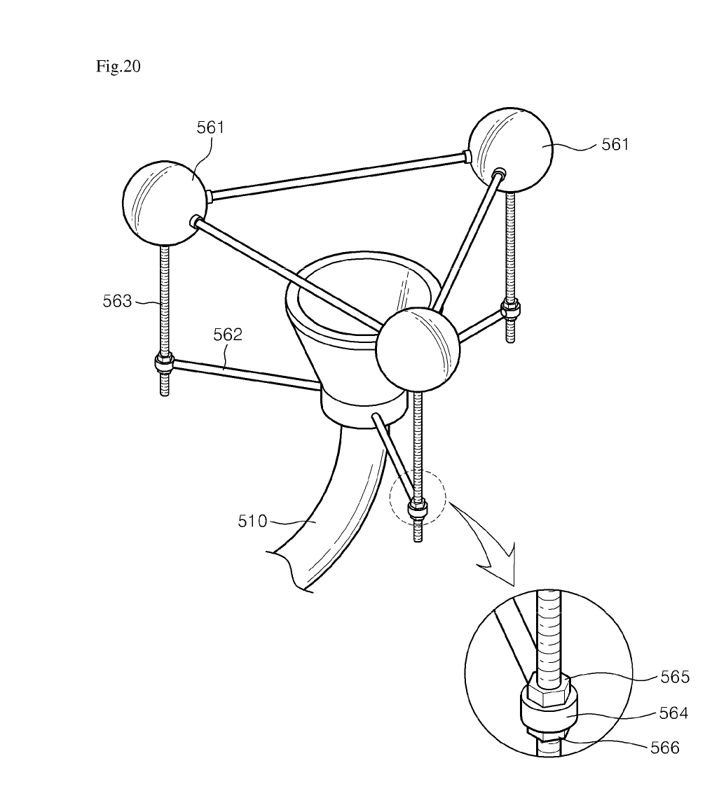

Meanwhile, FIGS. 18 to 20 illustrate a separator body 700 according to still another embodiment of the present invention.

Referring to the drawings, the separator body 700 includes a main housing 710 having the separation space formed therein, the mixed water introducing part 140 provided at a front end thereof, and the drainage unit 200 installed at a rear end thereof, and an induction unit 720 having a plurality of induction plates installed in the main housing 710 to increase a movement distance of the mixed water introduced into the main housing 710 and thus to increase a period of time in which the mixed water remains in the main housing 710.

The main housing 710 has a square cross section and extends forward and backward a predetermined length. The mixed water introducing part 140 is connected and in communication with a lower portion of a front surface of the main housing 710, and the second drainage pipe 212 is installed at a lower portion of a rear surface of the main housing 710 to pass therethrough.

Further, the oil discharging part 150 is connected with the rear surface of the main housing 710 which is spaced upward from the second drainage pipe 212. At this time, the oil discharging part 150 is preferably installed higher than the upper end of the third drainage pipe 213 so as to be located higher than a level of the water in the main housing 710.

A deposit discharging pipe 711 configured to discharge a deposit is installed at a bottom surface between the mixed water introducing part 140 and the induction plate, between the induction plates, and between the rearmost induction plate and the rear surface. An opening/closing valve is installed at the deposit discharging pipe 711 to be selectively opened and closed by the operation.

The induction unit 720 includes a plurality of first induction plates 721 of which both ends extend left and right to be in contact with left and right inner walls of the main housing 710 facing each other and in which a first water passing hole 723 is formed at each left lower portion thereof to allow the water to pass therethrough, and a plurality of second induction plates 722 of which both ends extend left and right to be in contact with left and right inner walls of the main housing 710 facing each other and in which a second water passing hole 724 is formed at each right lower portion thereof to allow the water to pass therethrough.

The first and second induction plates 721 and 722 are formed in a plate shape having a predetermined thickness, and upper and lower ends thereof are formed to be in contact with a ceiling and bottom surfaces of the main housing 710 and thus to partition an internal space of the main housing 710 into a plurality of small spaces in a front and rear direction.

At this time, the first induction plate 721 has a plurality of first oil passing holes 731 formed at a right upper portion thereof to pass therethrough in a front and rear direction and thus provide oil paths at an upper side thereof so that the oil passes, and the second induction plate 721 has a plurality of second oil passing holes 732 formed at a left upper portion thereof to pass therethrough in a front and rear direction and thus provide oil paths at an upper side thereof so that the oil passes. At this time, the first and second oil passing holes 731 and 732 are preferably formed higher than the upper end of the third drainage pipe 213 to be located higher than the level of the water in the main housing 710.

In the first and second induction plates 721 and 722 configured as described above, since the first and second oil passing holes 731 and 732 are provided at the left and right sides thereof, the water is prevented from passing through the first and second oil passing holes 731 and 732 even when the main housing 710 is inclined left and right.

Further, since the first and second oil passing holes 731 and 732 are provided at the upper sides of the first and second induction plates 721 and 722, only the oil located on the surface of the water passes therethrough, and since the oil contained in the mixed water should be moved to the upper side of the main housing 710, it is possible to ensure a period of time in which the oil is separated from the mixed water.

Further, the plurality of first and second induction plates 721 and 722 are alternately arranged in the separation space between the mixed introducing part and the drainage unit in the front and rear direction, such that the mixed water is guided to flow zigzag. Since the first and second oil passing holes 731 and 732 are also alternately arranged, the oil separated from the mixed water is guided to flow zigzag.

At this time, although not illustrated, a filter member may be installed at the first water passing hole 723 of the first induction plate 721 and the second water passing hole 724 of the second induction plate 722 to filter foreign substances contained in the water.

The mixed water is introduced into the main housing 710 through the mixed water introducing part 140, and the introduced mixed water is moved along a zigzag passage formed in the main housing 710 by the first and second induction plates 721 and 722 toward the oil discharging part 150 provided at a rear portion of the main housing 710. While the mixed water is moved along the zigzag passage, the oil contained in the mixed water is moved to the surface layer of the water, and thus the oil-water separation is performed. The oil separated from the mixed water is discharged to an outer side through the oil discharging part 150, and the water from which the oil is separated is discharged through the drainage unit 200.

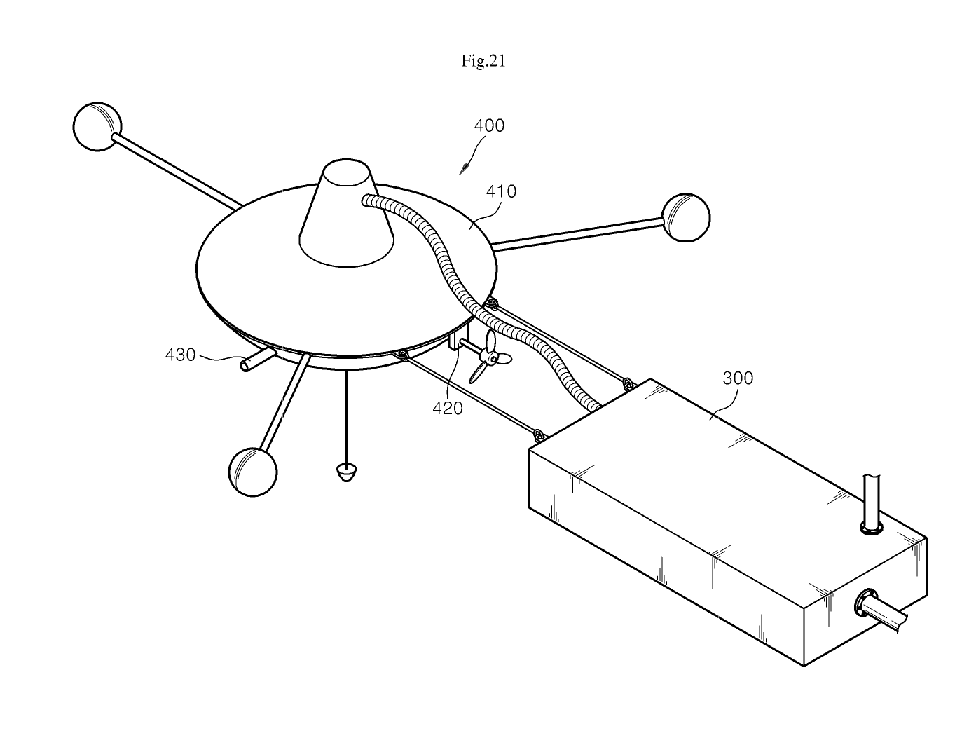

Meanwhile, FIG. 21 illustrates an oil discharging part 850 of still another embodiment of the present invention.

Referring to the drawing, one end of the oil discharging part 850 extends from an inner wall of the separator body 100 toward a center of the separator body 100. At this time, the oil discharging part 850 preferably extends in a direction orthogonal to the inner wall of the separator body 100.

As described above, the oil discharging part 850 is formed to be inserted into the separator body 100. Therefore, even when the separator body 100 is rotated by the waves, while installed in the ship 400 and then moved, the end of the oil discharging part 850 is inserted into the oil layer, and thus the oil may be more stably discharged to the outer side.

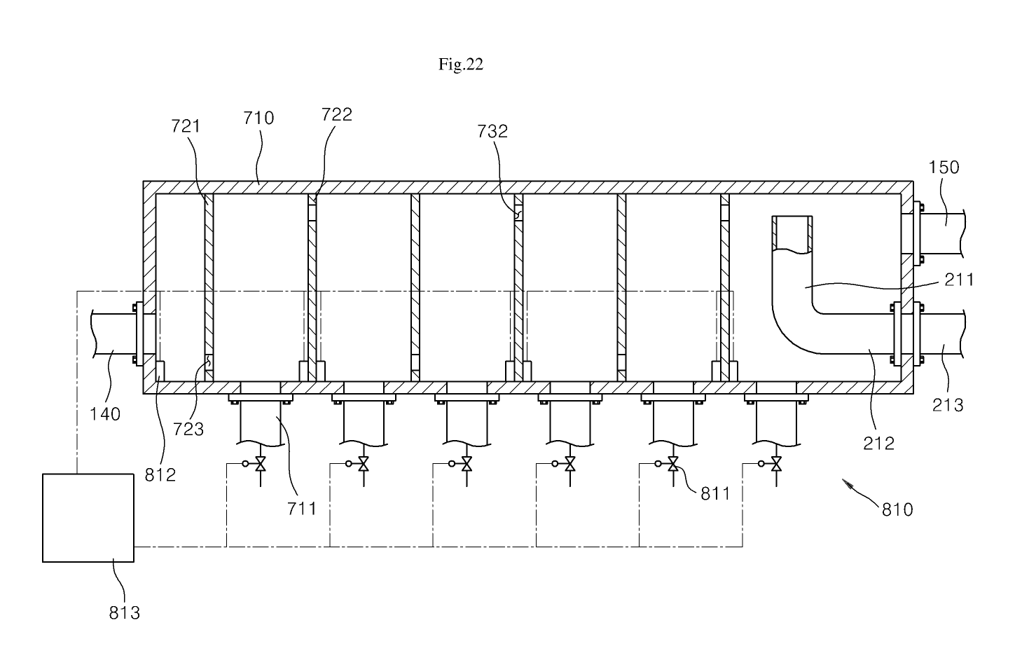

Meanwhile, FIG. 22 illustrates an apparatus 810 for separating and collecting oil spilled in the ocean according to still another embodiment of the present invention.

Referring to the drawing, the apparatus 810 for separating and collecting oil spilled in the ocean further includes a discharge opening/closing valve 811 installed at the deposit discharging pipe 711 to open and close the deposit discharging pipe 711, an oil detecting sensor 812 installed at a lower inner portion of the main housing 710 to detect oil deposited on the bottom surface of the main housing 710, and a control part 813 configured to control the discharge opening/closing valve 811 to open the deposit discharging pipe 711 when the oil is detected through the oil detecting sensor 812.

Preferably, the discharge opening/closing valve 811 is a solenoid valve which may be remote-controlled by a manager. The oil detecting sensor 812 detects the oil such as bunker-C oil deposited on the bottom surface of the main housing 710 and having a higher density than water, and may be configured with a viscosity detecting sensor, but is not limited thereto. As long as it is possible to detect the oil, any kinds of sensor may be used.

The control part 813 operates the discharge opening/closing valve 811 to open the deposit discharging pipe 711 when the oil deposited on the bottom surface of the main housing 710 is detected through the oil detecting sensor 812, and operates the discharge opening/closing valve 811 to close the deposit discharging pipe 711 when the oil is not detected through the oil detecting sensor 812. As described above, the apparatus 810 for separating and collecting oil spilled in the ocean according to the present invention may easily discharge the denser oil such as bunker-C oil deposited on the bottom surface of the main housing 710 to the outer side.

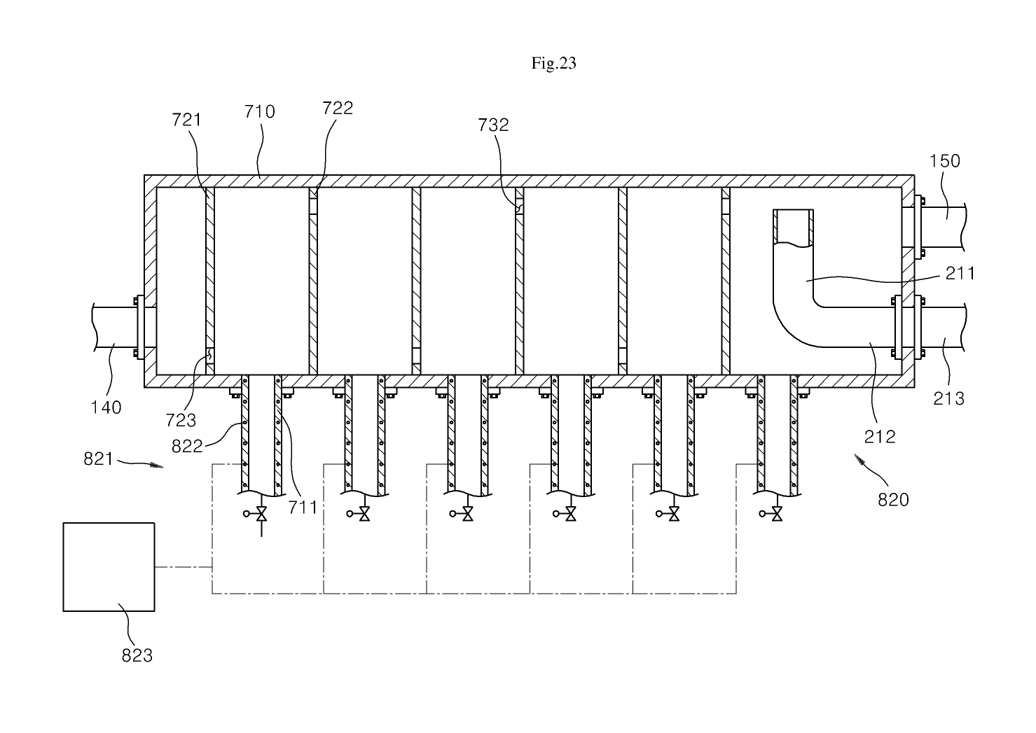

Meanwhile, FIG. 23 illustrates an apparatus 820 for separating and collecting oil spilled in the ocean according to yet another embodiment of the present invention.

Referring to the drawing, the apparatus 820 for separating and collecting oil spilled in the ocean further includes an oil heating part 821 which heats the oil to reduce a viscosity of the oil, such that the oil is easily discharged through the deposit discharging pipe 711.

The oil heating part 821 includes a plurality of electric heating wires 822 installed in an inner wall of each deposit discharging pipe 711 to generate heat by supplied electric power, and a power supply member 823 connected with the electric heating wires 822 to supply the electric power to the electric heating wires 822. The electric heating wires 822 are formed in a spiral shape with a center line of the deposit discharging pipe 711 in the center.

The bunker-C oil deposited on the bottom surface of the main housing 710 is not smoothly discharged to the deposit discharging pipe 711 due to its high viscosity, and the oil heating part 821 heats the bunker-C oil in the deposit discharging pipe 711 to reduce the viscosity, such that the bunker-C oil may be easily discharged.

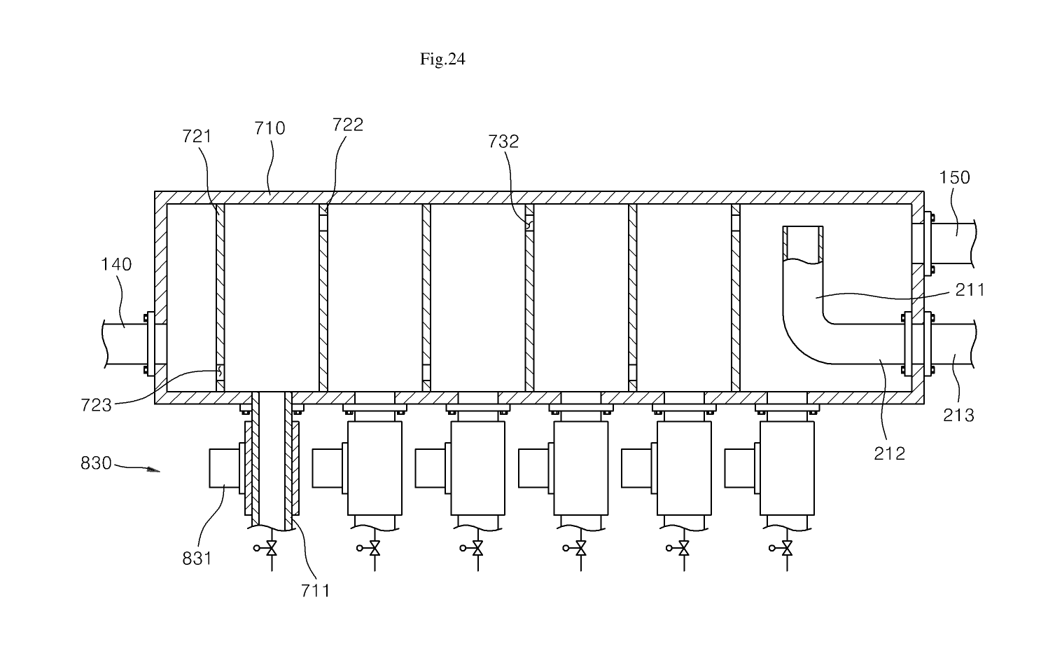

FIG. 24 illustrates an oil heating part 830 according to yet still another embodiment of the present invention.

Referring to the drawing, the oil heating part 830 includes a plurality of microwave generators 831 installed at each deposit discharging pipe 711 to radiate microwaves into the deposit discharging pipe 711 and thus to heat the oil flowing through the deposit discharging pipe 711.

The bunker-C oil in the deposit discharging pipe 711 is heated by the microwaves generated from the microwave generator 831, and thus the viscosity thereof is gradually reduced, and the bunker-C oil having a low viscosity is easily discharged through the deposit discharging pipe 711 to the outer side of the main housing 710.

Meanwhile, although not illustrated, a heat generating body configured to generate heat due to the microwaves may be installed between the microwave generator 831 and the deposit discharging pipe 711. The heat generating body is formed of silicon carbide (Sic), but is not limited thereto. If necessary, the heating generating body may be formed of a compound in which silicon dioxide (SiO₂), aluminum oxide (Al₂O₃), yttrium (Y₂O₃) or the like is mixed with the silicon carbide.

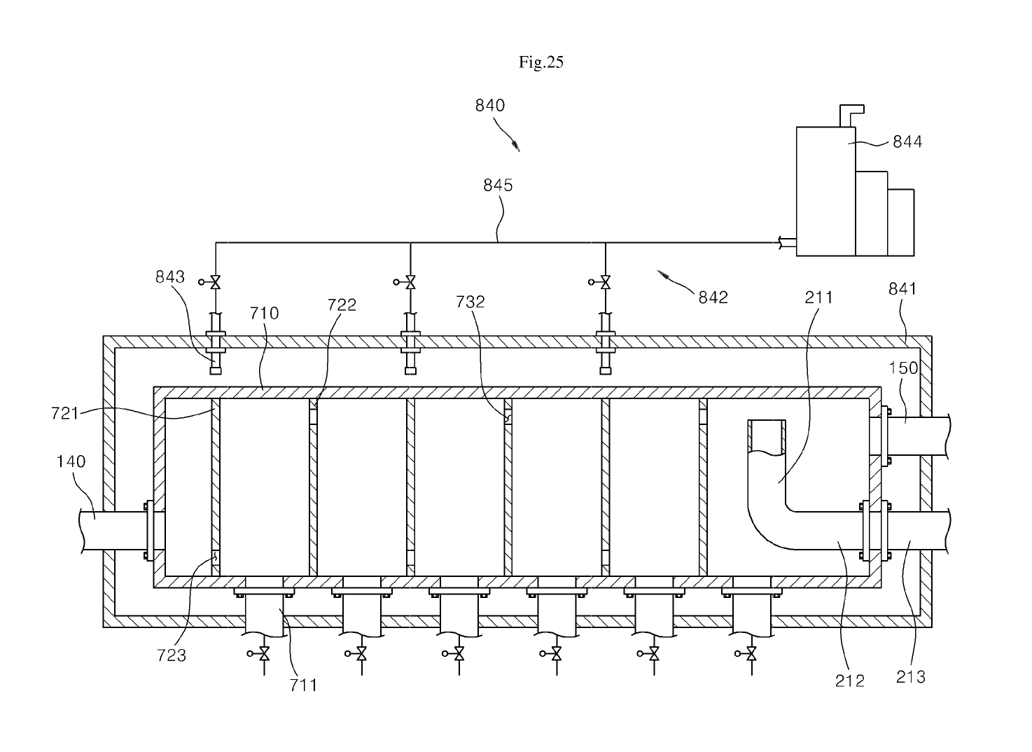

Meanwhile, FIG. 25 illustrates an oil heating part 840 according to another embodiment of the present invention.

Referring to the drawing, the oil heating part 840 includes an external case 841 having an installation space to receive the main housing 710 therein, and a steam supply 842 installed at the external case 841 to heat the external case 841 and configured to supply high temperature steam into the installation space.

The steam supply 842 includes a plurality of steam nozzles 843 installed at the external case 841 to inject steam into the installation space, and a steam boiler 844 installed at the steam nozzles 843 through a steam supply pipe 845 to supply the high temperature steam to the steam nozzles 843.

The oil heating part 840 sprays the high temperature steam to an outer surface of the main housing 710 to heat the main housing 710, and thus to reduce the viscosity of the oil in the main housing 710. Therefore, the viscosity of the bunker-C oil deposited on the bottom surface of the main housing 710 is gradually reduced, and thus easily discharged to the outer side of the main housing 710 through the deposit discharging pipe 711.

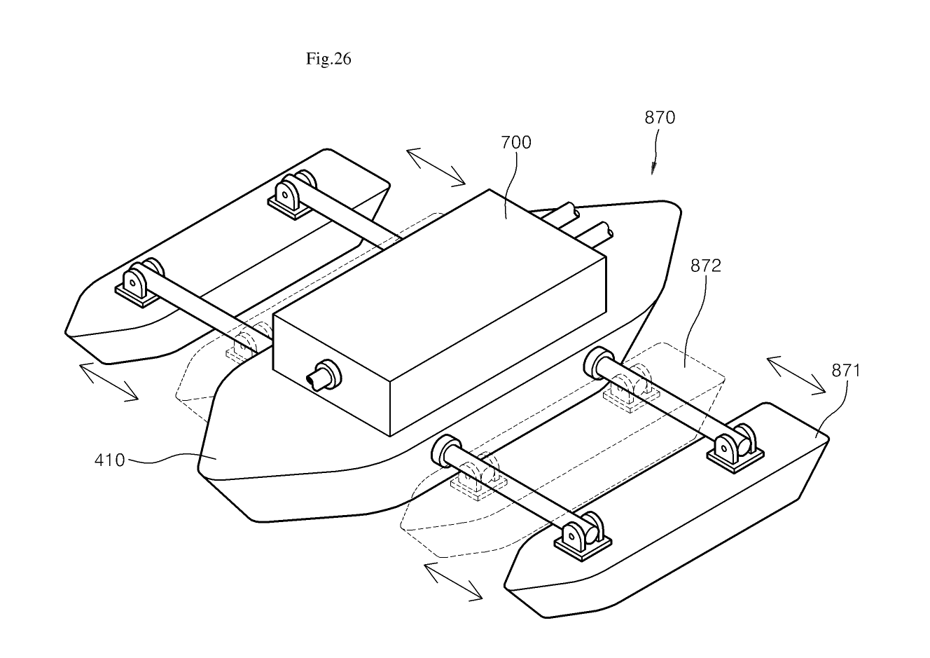

Meanwhile, FIG. 26 is a perspective view of a ship 870 according to still another embodiment of the present invention.

Referring to the drawing, the ship 870 includes a plurality of subsidiary buoyant members 871 installed at both sides of the ship body 410 to be moved forward and backward in a direction which is gradually away from the ship body 410 and also to be floated in the operation area, and a forward and backward driving part 872 which moves the subsidiary buoyant member 871 forward and backward.

The forward and backward driving part 872 includes a plurality of actuators of which one ends are installed in the ship body 410, and the other ends are rotatably installed at the subsidiary buoyant member 871, such that a distance from the one end to the other end is changed. When the big waves rise in the operation area, the subsidiary buoyant member 871 protrudes in the direction which is gradually away from the ship body 410 due to the forward and backward driving part 872 and thus supports the ship body 410 so as to reduce shake of the ship body 410 due to the big waves. Since shake of the mixed water received in the separator body 700 is reduced by the subsidiary buoyant member 871, even when the big waves rise, the oil is not mixed with the water, but may be easily separated so as to form a layer on the water.

Although a few embodiments of the present invention have been shown and described, it would be appreciated by those skilled in the art that changes may be made in these embodiments without departing from the principles and spirit of the invention, the scope of which is defined in the claims and their equivalents.

1. An apparatus for separating and collecting oil spilled in an ocean, comprising:
a separator body having a separation space therein formed to receive mixed water in which water and oil are mixed, and a mixed water introducing part formed at one side thereof to introduce the mixed water; and
a drainage unit which is installed in the separation space, and in which an end thereof is connected and in communication with the separator body to be located lower than a level of the water, such that the water separated from the oil due to a density difference is discharged to an outer side of the separator body.

2. The apparatus of claim 1, wherein the drainage unit comprises a drainage member which is installed in the separation space, and in which an end thereof is connected and in communication with the separator body to be located lower than the level of the water, such that the water separated from the oil due to the density difference is discharged to the outer side of the separator body, and
a length adjusting part configured to move a height of an upper end of the drainage member exposed to the outer side of the separator body vertically to control the level of the water in the separator body.

3. The apparatus of claim 2, wherein the separator body has the mixed water introducing part formed at one side thereof, and an oil discharging part formed at an upper portion thereof so that the oil is discharged therethrough, and
the drainage member has a first drainage pipe installed in the separator body to extend vertically and having an inlet port to allow the water from which the oil is separated to be introduced therethrough, a second drainage pipe configured to extend from a lower end of the first drainage pipe to an outer side of the separator body, a third drainage pipe configured to extend upward from an end of the second drainage pipe, and a fourth drainage pipe configured to extend from an upper end of the third drainage pipe to be horizontal or inclined downward, and
the length adjusting part is installed at the third drainage pipe to move a height of an upper end of the third drainage pipe vertically.

4. The apparatus of claim 3, wherein the length adjusting part is formed at one side of the third drainage pipe, and configured with a bellows tube which is contractible and expandable.

5. The apparatus of claim 3, wherein the length adjusting part comprises an internal pipe formed at the upper end of the third drainage pipe to extend upward, an external pipe formed to surround an outer circumferential surface of the internal pipe and to be moved vertically, and a sealing member installed at the internal pipe or the external pipe to prevent the water from leaking through a gap between the internal pipe and the external pipe.

6. The apparatus of claim 3, wherein the length adjusting part comprises a bellows tube formed at one side of the third drainage pipe to be expandable or contractible, an upper panel installed at an upper end of the bellows tube, a lower panel installed at a lower end of the bellows tube, a screw member configured to extend downward from the upper panel so as to pass through the lower panel and having a screw thread formed on an outer circumferential surface thereof, a worm wheel member rotatably installed at the lower panel and having a hollow through which the screw member passes and a screw thread formed on an inner circumferential surface of the hollow to be screwed with the screw member, a worm engaged with an outer circumferential surface of the worm wheel member, and a driving motor connected with the worm to rotate the worm.

7. The apparatus of claim 3, wherein the length adjusting part comprises a flexible tube provided between the second drainage pipe and the third drainage pipe, and an actuator configured to pivot the third drainage pipe vertically about the flexible tube.

8. The apparatus of claim 3, wherein the length adjusting part comprises a bellows tube formed at one side of the third drainage pipe to be expandable or contractible, a connection part installed at an upper portion of the bellows tube to be connected with the third drainage pipe, a connection rod configured to extend from the connection part toward the separator body, a first moving member connected with the connection rod to be moved vertically along the separator body, a second moving member formed in the separator body to be moved vertically, and a buoyant sphere connected with the second moving member and having a lower density than water, and
the first and second moving members are coupled with each other by a magnet so that the first moving member is moved vertically according to movement of the second moving member which is moved by vertical movement of the buoyant sphere.

9. The apparatus of claim 1, further comprising a subsidiary separator configured to secondarily separate oil contained in filtered water discharged through the drainage unit.

10. The apparatus of claim 1, further comprising a ship in which the separator body is installed to float in an operation area on which the oil is spilled, such that the mixed water is introduced into the separator body from the operation area,
wherein the ship comprises a ship body in which the separator body is installed to float in the operation area, and a ship propulsion part installed at the ship body to move the ship body.

11. The apparatus of claim 10, wherein the separator body has the mixed water introducing part formed at one side thereof and an oil discharging part formed at an upper portion thereof to discharge oil therethrough, and
the ship is floated in the operation area and further includes a buoyant tank connected with the oil discharging part to receive the oil discharged through the oil discharging part.

12. The apparatus of claim 1, further comprising a supply unit installed at the separator body to supply the mixed water to the separator body,
wherein the supply unit comprises a suction pipe configured to suck the mixed water at a position adjacent to a surface of water on which the oil floats, a suction tank installed at the suction pipe to introduce the mixed water sucked through the suction pipe, a suction impeller configured to discharge internal air of the suction tank to an outer side and thus to reduce an internal pressure of the suction tank, an outlet pipe configured to connect the suction tank with the mixed water introducing part, and first to third valves configured to open and close each connection portion between the suction tank and the suction pipe, between the suction tank and the suction impeller and between the suction tank and the outlet pipe.

13. The apparatus of claim 12, wherein the supply unit comprises a bypass pipe installed at the suction tank to introduce external air into the suction tank, a water level measuring sensor installed at the suction tank to measure a water level in the suction tank, a fourth valve installed at the bypass pipe to open and close the bypass pipe, and a control part configured to control the fourth valve to open the bypass pipe, such that the external air is introduced into the suction tank when the water level in the suction tank is higher than a predetermined water level based on information of the water level measured by the water level measuring sensor.

14. The apparatus of claim 13, wherein the supply unit further comprises an inlet port floating means installed at an end of the suction pipe to float an inlet port of the suction pipe toward the surface of the water in the operation area.

15. The apparatus of claim 14, wherein the inlet port floating means comprises a support frame installed at the end of the suction pipe, a buoyant member configured to float on a surface layer of the water or the oil in the operation area, and a rod member configured to support the support frame to be spaced downward from the buoyant member, and
the suction pipe comprises a buoyant pipe of which one end is installed at the inlet port floating means so that an inlet port thereof is floated toward the surface of the water in the operation area by the inlet port floating means, a receiving body installed at the other end of the buoyant pipe and having a receiving space therein to receive the mixed water introduced through the buoyant pipe, and a communication pipe of which both ends are connected with a lower portion of the receiving body and the suction tank so as to supply the mixed water received in the receiving body to the suction tank.

16. The apparatus of claim 3, further comprising a filter unit installed at the inlet port side of the first drainage pipe to filter foreign substances contained in the mixed water.

17. The apparatus of claim 1, wherein the separator body comprises a main housing in which the separation space is formed, the mixed water introducing part is provided at a front end thereof, and the drainage unit is installed at a rear end thereof, and an induction unit having a plurality of induction plates installed in the main housing to increase a movement distance of the mixed water introduced into the main housing and thus to increase a period of time in which the mixed water remains in the main housing.

18. The apparatus of claim 17, wherein the induction unit comprises a first induction plate of which both ends extend left and right to be in contact with left and right inner walls of the main housing facing each other, and a lower end is in contact with a bottom surface of the main housing, and in which a first water passing hole is formed at a left lower portion thereof to allow the water to pass therethrough, and a second induction plate of which both ends extend left and right to be in contact with left and right inner walls of the main housing facing each other, and a lower end is in contact with the bottom surface of the main housing, and in which a second water passing hole is formed at a right lower portion thereof to allow the water to pass therethrough, and
a plurality of first and second induction plates are alternately arranged in the separation space between the mixed introducing part and the drainage unit in a front and rear direction, such that the mixed water is guided to flow zigzag.

19. The apparatus of claim 18, wherein the first and second induction plates have oil paths formed at upper portions thereof, and the oil paths are formed to be located higher than a level of the water in the separator body.

20. The apparatus of claim 19, wherein the first induction plate has a first oil passing hole formed at a right upper portion thereof to pass therethrough and thus to provide the oil path, such that the oil passes, and the second induction plate has a second oil passing holes formed at a left upper portion thereof to pass therethrough and thus to provide the oil path, such that the oil passes.

21. The apparatus of claim 3, wherein one end of the oil discharging part extends from an inner wall of the separator body toward a center of the separator body.

22. The apparatus of claim 2, wherein the separator body has the mixed water introducing part formed at one side thereof and an oil discharging part formed at an upper portion thereof to discharge the oil, and
the oil discharging part comprises an internal extension pipe of which one end extends to an inner side of the separator body, a subsidiary bellows tube connected and in communication with one end of the internal extension pipe to be vertically expandable and contractible and having an outlet port through which the oil in the separator body is introduced, and a buoyant member installed at the subsidiary bellows tube by a connecting rod and having a lower density than water so that the outlet port is located at an oil layer in the separator body.

23. The apparatus of claim 22, wherein the oil discharging part further comprises a vertical movement guiding member configured to guide a position of the buoyant member which is moved vertically, and
the vertical movement guiding member is installed in the separator body to have a hollow configured to extend vertically, such that the buoyant member is inserted therein, and a guide hole formed in an outer circumferential surface thereof to extend vertically, such that the connecting rod passes therethrough.

24. The apparatus of claim 17, further comprising a deposit discharging pipe installed at a lower portion of the main housing to be in communication with the separation space and thus to discharge oil deposited on a bottom surface of the main housing to an outer side; a discharge opening/closing valve installed at the deposit discharging pipe to open and close the deposit discharging pipe; an oil detecting sensor installed at a lower inner portion of the main housing to detect the oil deposited on the bottom surface of the main housing; and a control part configured to control the discharge opening/closing valve to open the deposit discharging pipe when the oil is detected through the oil detecting sensor.

25. The apparatus of claim 17, further comprising a deposit discharging pipe installed at a lower portion of the main housing to be in communication with the separation space and thus to discharge oil deposited on a bottom surface of the main housing to an outer side; and an oil heating part configured to heat the oil to reduce a viscosity of the oil, such that the oil is easily discharged through the deposit discharging pipe.

26. The apparatus of claim 25, wherein the oil heating part comprises an electric heating wire installed at the deposit discharging pipe to generate heat by supplied electric power, and a power supply member configured to supply the electric power to the electric heating wire.

27. The apparatus of claim 25, wherein the oil heating part comprises at least one microwave generator installed at the deposit discharging pipe to radiate microwaves into the deposit discharging pipe and thus to heat the oil flowing through the deposit discharging pipe.

28. The apparatus of claim 25, wherein the oil heating part comprises an external case having an installation space to receive the main housing therein, and a steam supply installed at the external case to heat the external case and configured to supply high temperature steam into the installation space.

29. The apparatus of claim 10, wherein the ship comprises a plurality of subsidiary buoyant members installed at both sides of the ship body to be moved forward and backward in a direction which is gradually away from the ship body and to float in the operation area, and a forward and backward driving part configured to move the subsidiary buoyant member forward and backward.
